(19) United States
(12) Patent Application Publication
(10) Pub. No.: US 2017/0131721 A1
(43) Pub. Date: May 11, 2017

(54) ROBOT CLEANER AND METHOD FOR CONTROLLING THE SAME

(71) Applicant: Samsung Electronics Co., Ltd., Suwon-si (KR)

(72) Inventors: No San KWAK, Suwon-si (KR); Soon Yong Park, Bucheon-si (KR); Bo Young Kim, Incheon (KR); Kyung Shik Roh, Seongnam-si (KR); Suk June Yoon, Seoul (KR); Min Yong Choi, Suwon-si (KR)

(73) Assignee: Samsung Electronics Co., Ltd., Suwon-si (KR)

(21) Appl. No.: 15/287,923

(22) Filed: Oct. 7, 2016

(30) Foreign Application Priority Data
Nov. 6, 2015 (KR) 10-2015-0155739

(51) Int. Cl. G05D 1/02; B25J 11/00

(52) U.S. Cl. CPC G05D 1/0274; G05D 1/0214; B25J 11/0085; Y10S 901/01; G05D 2201/0203

(57) ABSTRACT

A robot cleaner and a method for controlling the same are disclosed. The robot cleaner includes a main body; a driver configured to move the main body; a storage configured to store a topological map and a grid map generated on the basis of a floor plan of a cleaning space; and a controller configured to control the driver in a manner that the main body travels in the cleaning space on the basis of the topological map and the grid map. The topological map and the grid map are generated prior to initial traveling of the cleaning space.

### CROSS-REFERENCE TO RELATED APPLICATION

This application claims the benefit of Korean Patent Application No. 10-2015-0155739, filed on Nov. 6, 2015 in the Korean Intellectual Property Office, the disclosure of which is incorporated herein by reference.

### BACKGROUND

1. Field

Embodiments of the present disclosure relate to a robot cleaner and a method for controlling the same, and more particularly to a robot cleaner configured to automatically clean a cleaning space while traveling about the cleaning space, and a method for controlling the same.

2.Description of the Related Art

A robot cleaner (also called a cleaning robot) is an apparatus that automatically cleans a region to be cleaned (hereinafter referred to as a cleaning space) by suctioning impurities, such as dust, etc., from a floor while autonomously traveling about the cleaning space without user intervention. That is, the robot cleaner cleans the cleaning space while traveling about the cleaning space.

Since a conventional robot cleaner does not store information regarding the cleaning space in advance, the robot cleaner has been designed to generate a map of the cleaning space while moving in the cleaning space.

In order to generate the map of the cleaning space as described above, the conventional robot cleaner requires a plurality of sensors configured to collect environmental information of the cleaning space and a high-priced processor configured to generate the map.

As a result, the conventional robot cleaner must travel about the cleaning space, irrespective of a function of cleaning the cleaning space, so as to generate the map, resulting in increased production costs of the robot cleaner.

### SUMMARY

Therefore, it is an aspect of the present disclosure to provide a robot cleaner including topological and grid maps stored before first traveling in a cleaning space, and a method for controlling the same.

It is another aspect of the present disclosure to provide a robot cleaner for modifying topological and grid maps stored before first traveling in a cleaning space according to a user input signal, and a method for controlling the same.

It is another aspect of the present disclosure to provide a robot cleaner for modifying topological and grid maps stored before first traveling in a cleaning space according to a traveling record, and a method for controlling the same.

Additional aspects of the disclosure will be set forth in part in the description which follows and, in part, will be obvious from the description, or may be learned by practice of the disclosure.

In accordance with one aspect of the present disclosure, a robot cleaner may include: a main body; a driver configured to move the main body; a storage configured to store a topological map and a grid map generated on the basis of a floor plan of a cleaning space; and a controller configured to control the driver such that the main body travels in the cleaning space on the basis of the topological map and the grid map. The topological map and the grid map may be generated prior to initial traveling of the cleaning space.

The topological map may include at least one cleaning node indicating at least one cleaning region contained in the cleaning space, and a connectivity relationship between the at least one cleaning node.

The at least one cleaning node may be generated from at least one of letters, numbers, symbols, and images displayed on the floor plan.

The connectivity relationship between the at least one cleaning node may be generated from a shortest path between at least one of letters, numbers, symbols, and images displayed on the floor plan.

The grid map may be divided into a plurality of cleaning blocks. The cleaning blocks may include position information of the cleaning blocks respectively, and are grouped into at least one cleaning region.

The grid map may be generated from a traveling simulation of a three-dimensional (3D) spatial model of the floor plan.

The grid map may be generated on the basis of a traveling record obtained while a 3D robot model of the robot cleaner travels in the 3D spatial model.

The topological map or the grid map may be modified by a user input.

Names of at least some cleaning nodes from among at least one cleaning node contained in the topological map may be modified by the user input.

At least some cleaning nodes from among at least one cleaning node contained in the topological map may be deleted by the user input.

A cleaning region corresponding to at least some deleted cleaning nodes from among at least one cleaning region contained in the grid map may be deleted.

The robot cleaner may further include an obstacle detector configured to detect an obstacle located in the cleaning space. the controller determines a position of the main body in the topological map and the grid map on the basis of an output signal of the obstacle detector.

The controller may determine the position of the main body in the topological map and the grid map on the basis of at least one of radio frequency (RF) signal strength of an access point (AP), illumination of a lamp, and geomagnetic strength.

The controller may generate a traveling path on the basis of the topological map and the grid map.

The robot cleaner may further include an obstacle detector configured to detect an obstacle located in the cleaning space, and a movement detector configured to measure movement of the main body. While the robot cleaner travels along the traveling path, the controller may modify the topological map and the grid map on the basis of an output signal of the obstacle detector and an output signal of the movement detector.

If the obstacle not shown in the topological map and the grid map is detected by the obstacle detector, the controller may control the driver in a manner that the main body travels along an outline of the obstacle.

While the main body travels along the outline of the obstacle, the controller may store a traveling record on the basis of an output signal of the movement detector.

The controller may modify the topological map and the grid map on the basis of a traveling record obtained during traveling.

In accordance with another aspect of the present disclosure, a method for controlling a robot cleaner may include: prior to initial traveling of a cleaning space, storing a topological map and a grid map on the basis of a floor plan of the cleaning space; traveling in the cleaning space on the basis of the topological map and the grid map; and modifying the topological map and the grid map when the robot cleaner travels in the cleaning space.

The topological map may include at least one cleaning node indicating at least one cleaning region contained in the cleaning space, and a connectivity relationship between the at least one cleaning node.

The at least one cleaning node may be generated from at least one of letters, numbers, symbols, and images displayed on the floor plan.

The connectivity relationship between the at least one cleaning node may be generated from a shortest path between at least one of letters, numbers, symbols, and images displayed on the floor plan.

The grid map may be divided into a plurality of cleaning blocks. The cleaning blocks may include position information of the cleaning blocks, and are grouped into at least one cleaning region.

The grid map may be generated from a traveling simulation of a three-dimensional (3D) spatial model of the floor plan.

The grid map may be generated on the basis of a traveling record obtained while a 3D robot model of the robot cleaner travels in the 3D spatial model.

The traveling in the cleaning space on the basis of the topological map or the grid map may include: determining the position of the robot cleaner in the topological map and the grid map; and generating a traveling path on the basis of the topological map and the grid map.

The modifying the topological map and the grid map when the robot cleaner travels in the cleaning space may include: detecting an obstacle located in the cleaning space; detecting movement of the robot cleaner; and modifying the topological map and the grid map on the basis of the position of the obstacle and the movement of the robot cleaner.

The modifying the topological map and the grid map on the basis of the position of the obstacle and the movement of the robot cleaner includes: if an obstacle not shown in the topological map and the grid map is detected, traveling along an outline of the obstacle; storing movement of the robot cleaner while the robot cleaner travels along the outline of the obstacle; and modifying the topological map and the grid map on the basis of movement of the robot cleaner.

The method may further include: modifying the topological map and the grid map according to a user input.

The modifying the topological map and the grid map according to the user input may include modifying names of at least some cleaning nodes from among at least one cleaning node contained in the topological map by the user input.

The modifying the topological map and the grid map according to the user input may include deleting at least some cleaning nodes from among at least one cleaning node contained in the topological map by the user input.

The modifying the topological map and the grid map according to the user input may include deleting a cleaning region corresponding to at least some deleted cleaning nodes from among at least one cleaning region contained in the grid map.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram illustrating a robot cleaner according to an embodiment of the present disclosure;

FIG. 2 is a view illustrating the external appearance of a robot cleaner according to an embodiment of the present disclosure;

FIG. 3 is a view illustrating an internal structure of a robot cleaner according to an embodiment of the present disclosure;

FIG. 4 is a bottom view illustrating a bottom surface of a robot cleaner according to an embodiment of the present disclosure;

FIG. 5 is a conceptual diagram illustrating a method for allowing an obstacle detector contained in the robot cleaner to detect an obstacle located in a forward direction according to an embodiment of the present disclosure;

FIG. 6 is a conceptual diagram illustrating a method for allowing an obstacle detector contained in the robot cleaner to detect an obstacle located in a side direction according to an embodiment of the present disclosure;

FIG. 7 is a flowchart illustrating a method for generating map data according to an embodiment of the present disclosure;

FIG. 8 illustrates an example of a floor plan (FP) indicating a plan view;

FIG. 9 is a view illustrating a topological map generated by the map data generation method shown in FIG. 7 on the basis of the FP shown in FIG. 8;

FIG. 10 is a view illustrating a grid map generated by the map data generation method shown in FIG. 7 on the basis of the FP of FIG. 8;

FIG. 11 is a view illustrating a topological-grid map generated by the map data generation method shown in FIG. 7 on the basis of the FP of FIG. 8;

FIG. 12 is a flowchart illustrating a method for generating a topological map according to an embodiment of the present disclosure;

FIG. 13 is a view illustrating letter regions extracted by the topological map generation method of FIG. 12;

FIG. 14 is a view illustrating walls (W) extracted by the topological map generation method of FIG. 12;

FIG. 15 is a view illustrating the shortest path between a plurality of cleaning nodes generated by the topological map generation method of FIG. 12;

FIG. 16 is a flowchart illustrating a method for generating a grid map according to an embodiment of the present disclosure;

FIG. 17 is a view illustrating a three-dimensional (3D) spatial model generated by the grid map generation method of FIG. 16;

FIG. 18 is a view illustrating that a virtual robot cleaner travels according to the grid map generation method of FIG. 16;

FIG. 19 is a view illustrating a grid map generated by the grid map generation method of FIG. 16;

FIG. 20 is a flowchart illustrating a method for modifying a map according to one embodiment of the present disclosure;

FIGS. 21 to 30 illustrate examples for modifying the topological-grid map according to the map modification method of FIG. 20;

FIG. 31 is a flowchart illustrating a method for modifying a map according to another embodiment of the present disclosure;

FIGS. 32 to 34 are conceptual diagrams illustrating a method for determining the position of a robot cleaner according to the map modification method of FIG. 31;

FIGS. 35 and 36 are conceptual diagrams illustrating methods for allowing the robot cleaner traveling in the cleaning space to collect environmental information according to the map modification method of FIG. 31;

FIG. 37 is a view illustrating the topological-grid map modified by the map modification method of FIG. 31;

FIG. 38 is a conceptual diagram illustrating a method for displaying a cleaning progress state according to an embodiment of the present disclosure;

FIGS. 39 and 40 are conceptual diagrams illustrating examples for displaying a cleaning progress state according to the method of FIG. 38;

FIG. 41 is a conceptual diagram illustrating an exemplary interaction between the robot cleaner and a user terminal (also called a user equipment UE) according to an embodiment of the present disclosure;

FIGS. 42, 43, and 44 illustrate examples of interaction between the robot cleaner and the user equipment (UE) according to the method of FIG. 41;

FIG. 45 illustrates another example of interaction between the robot cleaner and the user equipment (UE) according to an embodiment of the present disclosure;

FIGS. 46 and 47 illustrate examples of interaction between the robot cleaner and the user equipment (UE) according to the method of FIG. 45;

### DESCRIPTION OF EMBODIMENTS

Reference will now be made in detail to the embodiments of the present disclosure, examples of which are illustrated in the accompanying drawings, wherein like reference numerals refer to like elements throughout.

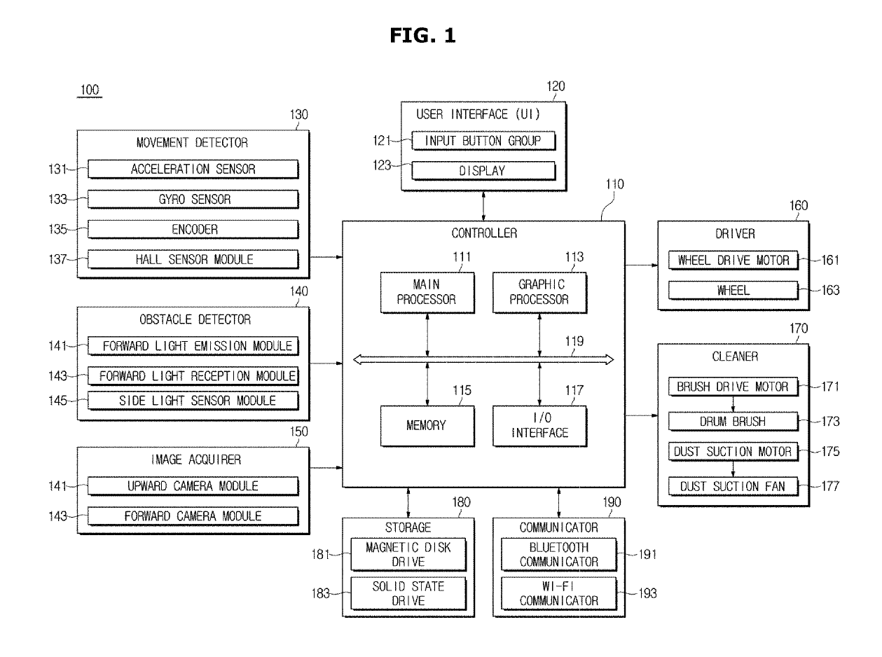

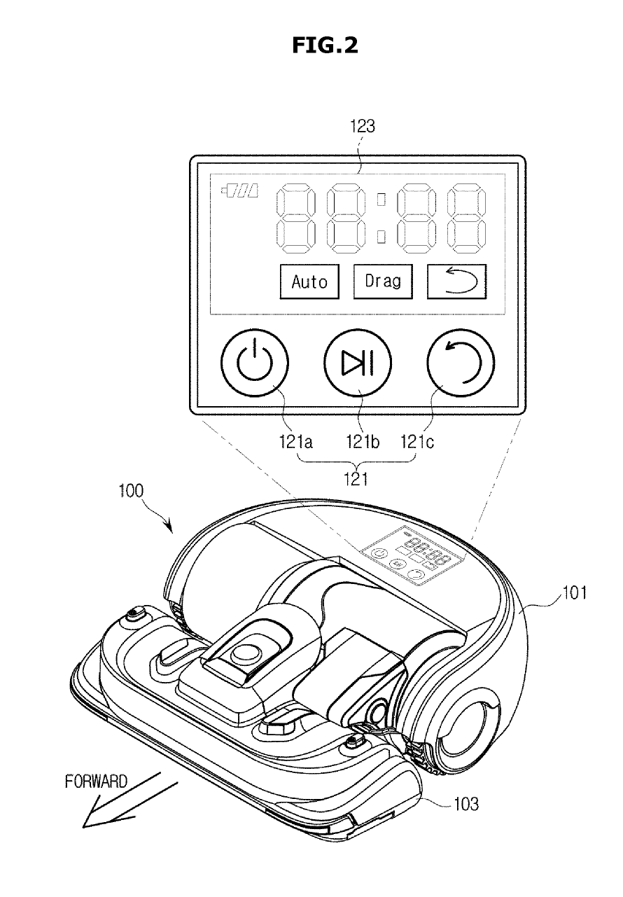

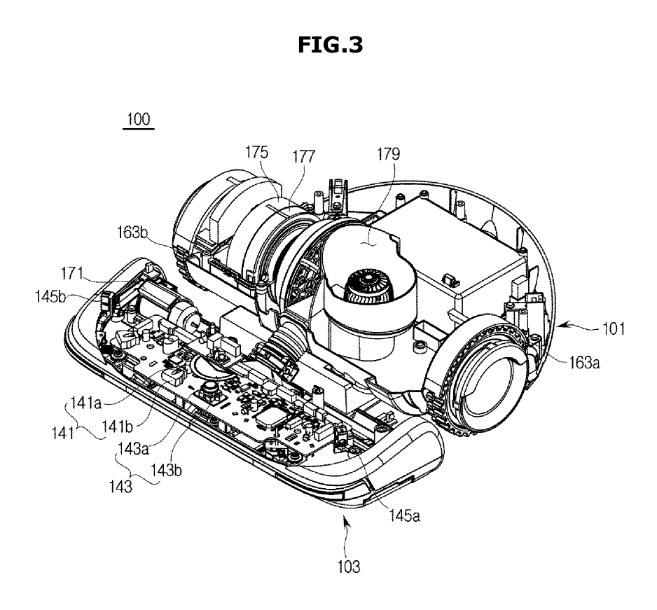

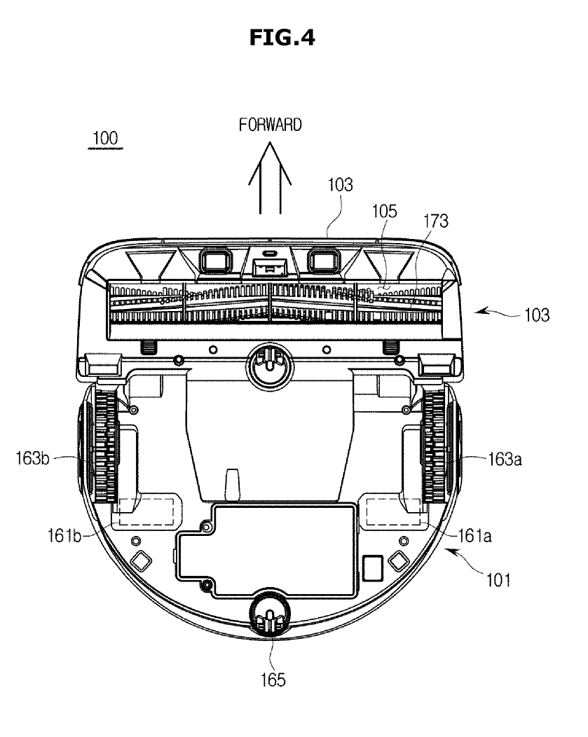

FIG. 1 is a block diagram illustrating a robot cleaner according to an embodiment of the present disclosure. FIG. 2 is a view illustrating the external appearance of the robot cleaner according to an embodiment of the present disclosure. FIG. 3 is a view illustrating an internal structure of the robot cleaner according to an embodiment of the present disclosure. FIG. 4 is a bottom view illustrating a bottom surface of the robot cleaner according to an embodiment of the present disclosure.

Referring to FIGS. 1 to 4, the robot cleaner 100 may include a main body 101 and a sub body 103. As shown in FIG. 2, the main body 101 may have an approximately semicircular shape, and the sub body 103 may have an approximately rectangular shape.

However, the shape of the robot cleaner 100 is not limited to the above-mentioned robot cleaner including the main body 101 and the sub body 103, the robot cleaner 100 may include a single body or at least three bodies. In addition, the main body 101 and the sub body 103 are designed to perform optimum cleaning, and the main body 101 is not limited to an approximately semicircular shape and the sub body 103 is not limited to an approximately rectangular shape. For example, the entire body of the robot cleaner 100 may have an approximately circular shape or may have an approximately rectangular shape.

Constituent elements for implementing the functions of the robot cleaner 100 may be disposed inside and outside the main body 101 and the sub body 103.

In more detail, the interior and exterior parts of the main body 101 and the sub body 103 may include a user interface (U I) configured for user interaction; a motion detector 130 configured to detect information related to movement of the robot cleaner 100; an obstacle detector 140 configured to detect an obstacle disposed in a cleaning space; an image acquirer 150 configured to acquire a peripheral image of the robot cleaner 100; a driver 160 configured to move the robot cleaner 100; a cleaner 150 configured to clean the cleaning space; a storage 180 configured to store programs and data related to the operation of the robot cleaner 100; a communicator 190 configured to communicate with an external device; and a controller 110 configured to control the robot cleaner 100.

However, names of the constituent elements contained in the robot cleaner 100 are not limited to the user interface (UI) 120, the motion detector 130, the obstacle detector 140, the image acquirer 150, the driver 160, the cleaner 170, the storage 180, the communicator 190, and the controller 110, and it should be noted that the above-mentioned constituent elements may also be called other names having the same functions as necessary. The UI 120 may be disposed at the top surface of the main body 101 of the robot cleaner 100 as shown in FIG. 2, and may include a plurality of input buttons 121 configured to receive a control command from the user and a display 123 configured to display operation information of the robot cleaner 100.

The plurality of input buttons 121 may include a power button 121a to turn the robot cleaner 100 on or off, an operation button 121b to operate or stop the robot cleaner 100, and a return button 121c to allow the robot cleaner 100 to return to a charging station (not shown).

Each button contained in the plurality of input buttons 121 may be implemented as a push switch or a membrane switch to detect user pressurization, or may be implemented as a touch switch to detect contact of some parts of a user's body.

The display 123 may display information of the robot cleaner 100 in response to a control command entered by the user. For example, the display 123 may display the operation state of the robot cleaner 100, the power state, a user-selected cleaning mode, information indicating whether to return to the charging station, etc.

The display 123 may be implemented as a light emitting diode (LED), an organic light emitting diode (OLED), a liquid crystal display (LCD), or the like.

In addition, the display 123 may also be implemented as a touch screen panel (TSP) configured to receive a control command from a user as well as to display the operation information corresponding to the received control command.

The TSP may include a display for displaying operation information and user-input control commands, a touch panel for detecting coordinates contacting some parts of a user's body, and a touchscreen controller for determining the user-input control command on the basis of the contact coordinates detected by the TSP.

The touchscreen controller may compare user-touched coordinates detected through the touch panel with control command coordinates displayed through the display such that it can recognize the user-input control command.

The motion detector 130 may detect movement of the robot cleaner 100 while the robot cleaner 100 travels about the cleaning space A.

In more detail, the motion detector 130 may measure acceleration, a moving speed, a moving potential, a moving direction, etc. of the robot cleaner 100 while the robot cleaner 100 linearly moves in the cleaning space. In addition, the motion detector 130 may measure a rotation speed, a rotation potential, a rotation radius, etc. of the robot cleaner 100 while the robot cleaner 100 performs rotational movement.

The motion detector 130 may include an acceleration sensor 131 and a gyro sensor 133 to autonomously detect movement of the robot cleaner 100; and an encoder 135 and a Hall sensor module 137 to detect rotation of a wheel 163.

The acceleration sensor 131 may detect linear movement. For example, the acceleration sensor 131 may measure linear acceleration, linear speed, linear displacement, etc. of the robot cleaner 100 using Newton's second law of motion (i.e., Newton's law of acceleration).

The acceleration sensor 131 may be implemented as a small-sized micro-electric mechanical system (MEMS) sensor implemented by combining micro-mechanical technology, microelectric technology, and semiconductor technology.

The gyro sensor 133 may be referred to as a gyroscope or an angular velocity sensor, and may detect rotational movement of the robot cleaner 100. In more detail, the gyro sensor 133 may detect rotational angular speed and rotational displacement, etc. of a target object using the law of conservation of angular momentum, Sagnac effect, Coriolis force, etc.

The gyro sensor 133 may also be implemented using a Micro Electro Mechanical System (MEMS) sensor. For example, a capacitive gyro sensor from among the MEMS gyro sensors may detect deformation of a micromechanical structure caused by Coriolis force proportional to rotational speed using variation in capacitance, and may calculate the rotational speed on the basis of the variation in capacitance.

The encoder 135 may include a light emitting element (not shown) to emit light, a light receiving element (not shown) to receive light; and a rotational slit (not shown) and a fixed slit (not shown) disposed between the light emitting element and the light receiving element. The rotational slit may be designed to rotate with the wheel 153, and the fixed slit may be fixed to the main body 101.

Light emitted from the light emitting element passes through the rotational slit and arrives at the light receiving element according to rotation of the rotational slit, or may be cut off by the rotational slit according to movement of the rotational slit. As a result, the light receiving element may output an electric signal according to light received in response to rotation of the rotational slit.

In addition, the controller 110 may calculate a rotational speed and rotational displacement of the wheel 163 on the basis of the electric signal generated from the light receiving element, and may calculate a linear moving speed, a linear moving displacement, a linear moving speed, a linear moving displacement, etc. of the robot cleaner 100 on the basis of the rotational speed and rotational displacement of the wheel 163.

The Hall sensor module 137 may include a permanent magnet (not shown) to generate a magnetic field and a Hall sensor (not shown) to detect the magnetic field. Here, the permanent magnet may rotate with the wheel 163, and the Hall sensor may be fixed to the main body 101.

The Hall sensor may detect or may not detect the magnetic field generated by the permanent magnet according to rotation of the permanent magnet. As a result, the Hall sensor may output an electrical signal corresponding to the detected magnetic field according to rotation of the permanent magnet.

In addition, the controller 110 may calculate the rotational speed and the rotational displacement of the wheel 163 on the basis of the electric signal generated from the Hall sensor, and may calculate a linear moving speed, a linear moving displacement, a rotational moving speed, a rotational moving displacement, etc. of the robot cleaner 100 on the basis of the rotational speed and the rotational displacement of the wheel 163.

The obstacle detector 140 may detect an obstacle obstructing movement of the robot cleaner 100.

In this case, the obstacle may be any kind of object that can protrude from the bottom of the cleaning space and obstruct movement of the robot cleaner 100 or can be recessed from the bottom of the cleaning space and obstruct movement of the robot cleaner 100. For example, the obstacle may include furniture (such as a table, sofa, etc.), at least one wall for dividing the cleaning space into a plurality of sections, the front door lower in height than the bottom of the cleaning space, or the like.

The obstacle detector 140 may include a forward light emission module 141 to emit light in a forward direction of the robot cleaner 100, a forward light reception module 143 to receive light reflected from a forward obstacle, and a side light sensor module 145 to emit light in a side direction of the robot cleaner 100 and to receive light reflected from a side obstacle.

Although the robot cleaner 100 according to one embodiment is designed to use light such as infrared light so as to detect the obstacle, the scope of the robot cleaner 100 is not limited thereto and the robot cleaner 100 may also use laser, ultrasound, radio waves, etc.

As can be seen from FIG. 3, the forward light emission module 141 may include a light source 141a to emit light and a wide-angle lens 141b to diffuse the emitted light in a direction parallel to the floor to be cleaned.

The light source 141a may include a Light Emitting Diode (LED) or a Light Amplification by Simulated Emission of Radiation (LASER) diode configured to emit light in the proceeding direction of the robot cleaner 100.

The wide-angle lens 141b may be formed of a light transmission material, and may diffuse the light emitted from the light source 141a into the direction parallel to the floor to be cleaned using refraction or total reflection. The light emitted from the forward light emission module 141 may be diffused in a fan shape to the front of the robot cleaner 100. Hereinafter, the above-mentioned light is diffused in a direction parallel to the floor to be cleaned so that the light has a fan shape. For convenience of description and better understanding of the present disclosure, the above-mentioned light will hereinafter be referred to as plane light.

As described above, the forward light emission module 141 may emit plane light in the proceeding direction of the robot cleaner 100.

In addition, as can be seen from FIG. 3, the obstacle detector 140 may include a plurality of light emission modules 141 in such a manner that a specific part at which the plane light emitted from the forward light emission module 141 does not arrive has a minimum size.

The forward light reception module 143 may include a reflective mirror 143a to focus the light reflected from the obstacle, and an image sensor 143b to receive the light reflected from the reflective mirror 143a.

The image sensor 143b may be provided below the reflective mirror 143a, and may receive the light reflected from the reflective mirror 143a so that the proceeding direction of the received light is changed. In more detail, the image sensor 143a may obtain a two-dimensional (2D) image formed at the reflective mirror 143a through the light reflected from the obstacle.

In this case, the image sensor 143a may be comprised of a two-dimensional (2D) image sensor in which optical sensors are two-dimensionally arranged. In more detail, the image sensor 143b may include a Complementary Metal Oxide Semiconductor (CMOS) sensor or a Charge coupled device (CCD) sensor.

The image sensor 143b may be an image sensor 143b that is capable of receiving the light having the same wavelength as that of the light source 143a of the forward light emission module 141. For example, if the light source 141a emits the infrared light, the image sensor 143b is preferably an image sensor capable of obtaining an infrared image.

As described above, the forward light reception module 143 may acquire an image of an obstacle (hereinafter referred to as an obstacle image) generated by the light reflected from the obstacle located in the proceeding direction of the robot cleaner 100.

The number of forward light reception modules 143 may be different from the number of forward light emission modules 141. As described above, the forward light emission module 141 may diffuse the light emitted from the light source 141a in various directions using the wide-angle lens 141b, and the forward light reception module 143 may focus light beams of various directions on the image sensor 143a using the reflective mirror 143a, so that the obstacle detector 140 may include different numbers of forward light emission modules 141 and forward light reception modules 143.

The obstacle detector 140 to detect the obstacle located in the proceeding direction of the robot cleaner 100 is not limited to the forward light emission module 141 to generate plane light in the proceeding direction of the robot cleaner 100 as well as to the forward light reception module 143 to acquire an image generated by light reflected from the obstacle. For example, the obstacle detector 140 may include a light sensor module which emits linear light in a forward direction of the robot cleaner 100 and detects the position of the obstacle (O) using the light reflected from the obstacle (O).

The side light sensor module 145 may include a left light sensor module 145a and a right light sensor module 145b. The left light sensor module 145a may emit the light to the left of the robot cleaner 100, and receive the light reflected from the left obstacle. The right light sensor module 145b may emit the light to the right of the robot cleaner 100, and receive the light reflected from the right obstacle.

The light sensor module 145 may detect the obstacle and may also be used to perform traveling of the robot cleaner 100.

For example, during the outline tracing traveling mode in which the robot cleaner 100 travels while maintaining a predetermined distance with the obstacle, the side light sensor module 145 may detect the distance between the obstacle and the side of the robot cleaner 100, and the controller 110 may control the driver 160 on the basis of the measurement result of the side light sensor module 145 in such a manner that a predetermined distance between the robot cleaner 100 and the obstacle can be maintained.

The side light sensor module 145 may assist the forward light emission module 141 and the forward light reception module 143 that are configured to detect the obstacle located in a forward direction of the robot cleaner 100. If necessary, the obstacle detector 140 may not include the side light sensor module 145.

The image acquirer 150 may include an upward camera module 151 to acquire an upper image (i.e., the ceiling image) of the robot cleaner 100 and a forward camera module 153 to acquire an image of the traveling direction of the robot cleaner 100.

The upward camera module 151 may include an image sensor (not shown) provided at the top surface of the robot cleaner 100 to acquire an upward image of the robot cleaner 100 (i.e., the ceiling image of the cleaning space).

The forward camera module 153 may include an image sensor (not shown) provided at the front surface of the robot cleaner 100 to acquire an image of the traveling direction of the robot cleaner 100.

In addition, the image sensor contained in the upward camera module 151 or the forward camera module 153 may include a CMOS sensor or a CCD sensor.

The image acquirer 150 may output images acquired by the upward camera module 151 and the forward camera module 153 to the controller 110.

The controller 110 may determine the position of the robot cleaner 100 on the basis of the images acquired by the upward camera module 151 and the forward camera module 153. In more detail, the controller 110 may extract characteristic points from the images acquired by the upward camera module 151 and the forward camera module 153, and may determine a moving distance, a moving direction, a moving speed, etc. of the robot cleaner 100 on the basis of variation in position of the extracted characteristic points. In addition, the controller 110 may determine the position of the robot cleaner 100 on the basis of a moving distance, a moving direction, a moving speed, etc. of the robot cleaner 100.

The driver 160 may move the robot cleaner 100, and may include a wheel drive motor 161, a wheel 163, and a caster wheel 155 as shown in FIGS. 3 and 4.

The wheel 163 may be provided at both sides of the bottom surface of the main body 101, may include a left wheel 163a arranged to the left side of the robot cleaner 100 on the basis of the front part of the robot cleaner 100, and may further include a right wheel 163b arranged to the right side of the robot cleaner 100.

In addition, the wheel 163 may receive rotational force from the wheel drive motor 161 and move the robot cleaner 100 using the received rotational force.

The wheel drive motor 161 may generate the rotational force needed to rotate the wheel 163, and may include a left driving motor 161a to rotate the left wheel 163a and a right driving motor 161b to rotate the right wheel 163b.

Each of the left driving motor 161a and the right driving motor 161b may receive a drive control signal from the controller 110, so that the left driving motor 161a and the right driving motor 161b can be operated independently from each other.

By the left driving motor 161a and the right driving motor 161b, the left wheel 163a and the right wheel 163b may rotate independently.

In addition, since the left wheel 163a and the right wheel 163b can rotate independently, the robot cleaner 100 may move or travel in various ways (e.g., forward movement, backward movement, rotation, and rotation in place).

For example, if the right and left wheels (163a, 163b) rotate in a first direction, the robot cleaner 100 performs straight traveling in a forward direction. If the right and left wheels (163a, 163b) rotate in a second direction, the main body 101 may perform straight traveling in a backward direction.

In addition, the right and left wheels (163a, 163b) may rotate in the same direction. If the right and left wheels (163a, 163b) rotate at different speeds, the robot cleaner 100 rotates in the right or left direction. If the right and left wheels (163a, 163b) rotate in different directions, the robot cleaner 100 may rotate clockwise or counterclockwise in place.

The caster wheel 165 is installed at the bottom of the main body 101, so that the rotation axis of the caster wheel 165 may rotate in response to the movement direction of the robot cleaner 100. The caster wheel 165 having a rotation axis that rotates in response to the movement direction of the robot cleaner 100 does not disturb traveling of the robot cleaner 100, and the robot cleaner 100 can travel while maintaining a stable posture.

In addition, the traveling unit 160 may include a motor drive circuit (not shown) for providing drive current to the wheel drive motor 163 in response to a control signal of the controller 110; a power transmission module (not shown) for providing rotational force of the wheel drive motor 161 to the wheel 163; and a rotation sensor (not shown) for detecting rotational displacement and rotational speed of the wheel drive motor 161 or the wheel 163.

The cleaner 170 may include a drum brush 173 to scatter dirt or dust from the floor to be cleaned; a brush drive motor 171 to rotate the drum brush 173; a dust suction fan 177 to suck in the scattered dust; a dust suction motor 175 to rotate the suction fan 177; and a dust box 179 to store the sucked dust.

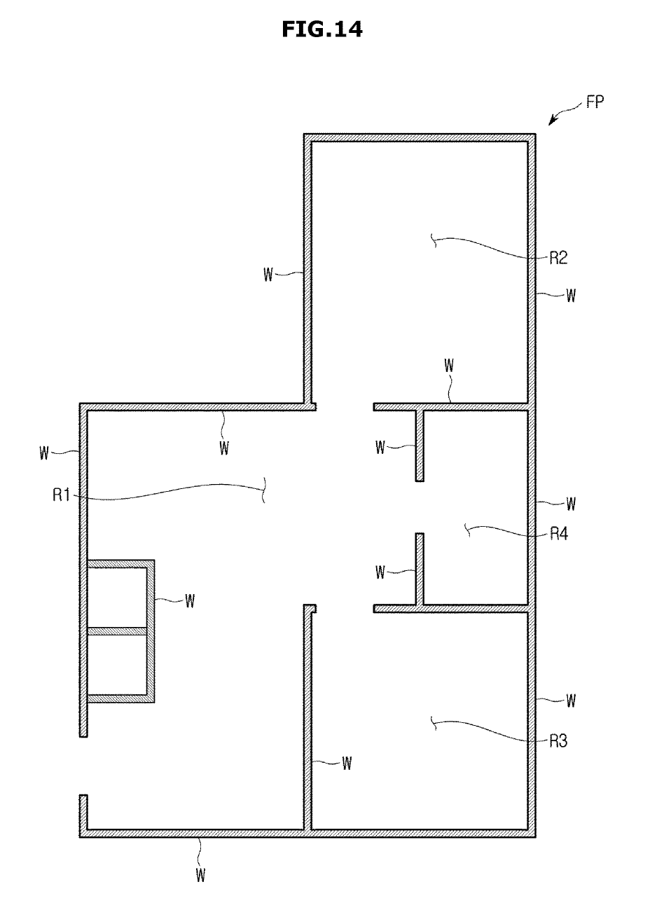

As shown in FIG. 14, the drum brush 173 is provided at the dust inlet 105 formed at the bottom of the sub body 103, and rotates about the rotation axis provided in a direction parallel to the floor to be cleaned, so that the dust from the floor to be cleaned is scattered into the dust inlet 105.

The brush drive motor 171 is arranged adjacent to the drum brush 173, so that it rotates the drum brush 173 in response to the cleaning control signal of the controller 110.

Although not shown in the drawings, the cleaner 170 may further include a motor drive circuit (not shown) to provide a drive current to the brush drive motor 171 in response to a control signal of the controller 110, and a power transmission module (not shown) to transfer rotational force of the brush drive motor 171 to the drum brush 173.

As shown in FIG. 3, the dust suction fan 177 is mounted to the main body 101 so that the dust scattered by the drum brush 173 is sucked into the dust box 179.

The dust suction motor 175 is arranged adjacent to the dust suction fan 177, and rotates the dust suction fan 177 in response to a control signal of the controller 110.

Although not shown in the drawings, the cleaner 170 may further include a motor drive circuit (not shown) to provide a drive current to the dust suction motor 175 in response to a control signal of the controller 110, and a power transmission module (not shown) to transfer rotational force of the suction motor 175 to the dust suction fan 177.

As shown in FIG. 3, the dust box 179 is provided at the main body 101, and may store the dust sucked by the suction fan 177.

In addition, the cleaner 170 may further include a dust guide pipe through which dust sucked through the dust inlet 105 is directed to the dust box 179 provided at the main body 101.

The storage 180 may store control programs and control data needed to control the robot cleaner 100, and may further store various application programs and application data needed to perform various functions in response to a user input.

For example, the storage 180 may store an operating system (OS) program to manage structures and resources (software and hardware) contained in the robot cleaner 100, an image processing program to process a reflected light image acquired by the obstacle detector 140, and a motor control program, etc. to control the drive motors 161 and 171 respectively contained in the drivers 160 and 170.

The storage 180 may act as an auxiliary memory device of the memory 115 to be described later.

Specifically, the storage 180 may store map data indicating a cleaning space map generated prior to initial traveling of the robot cleaner 100.

The cleaning space map may include a topological map including connectivity between a plurality of cleaning regions contained in the cleaning space, and a metric map, a grid map, or a geometry map indicating the shape of the cleaning space and the positions of obstacles. For convenience of description, the metric map, the grid map, and the geometry map will hereinafter be referred to only as “grid map”.

The grid map may perform spatial decomposition of the cleaning space so as to represent the cleaning space, and may also represent an arbitrary structure and object (obstacle).

In addition, the topological map may represent connectivity between the plurality of cleaning regions or the plurality of objects (obstacles), and may abstract the cleaning space using the plurality of cleaning regions and connection lines for interconnecting the cleaning regions.

The grid map and the topological map are formed before the robot cleaner 100 initially travels in the cleaning space, and are stored in the storage 180. In addition, the robot cleaner 100 may update the topological map and the grid map stored in the storage 180 while traveling about the cleaning space.

A method for forming the grid map and the topological map will hereinafter be described.

The storage 180 may include a non-volatile memory, stored data of which is not erased even when the robot cleaner 100 is powered off. For example, the storage 180 may include a hard disk drive 181, a solid state drive 183, or the like.

The communicator 190 may communicate with an access point (AP) for relaying wireless communication, a user equipment (UE) for mobile communication, and external devices such as other household appliances.

The communicator 190 may include various communicators (191, 193) and an antenna (not shown) according to a communication protocol. For example, the communicator 190 may include a Bluetooth (Bluetooth™) communicator 191, a W-Fi (W-Fi™) communicator 193, or the like. The Bluetooth communicator 192 has been widely used to perform data communication between a plurality of end nodes. The Wi-Fi communicator 193 is used to form a local area network (LAN) or to access a wide area network (WAN) such as the Internet.

The robot cleaner 100 may receive map data from the external device through the communicator 190, or may transmit map data to the external device through the communicator 190.

The controller 110 may control individual constituent elements contained in the robot cleaner 100.

The controller 110 may include an input/output (I/O) interface to mediate data communication between the controller 110 and various constituent devices contained in the robot cleaner 100, a memory 115 to store programs and data, a graphics processor 113 to perform image processing, and a main processor 111 to perform calculation operations according to the programs and data stored in the memory 113. In addition, the controller 110 may include a data bus 119 to mediate data communication among the I/O interface 117, the memory 115, the graphics processor 113, and the main processor 111.

The I/O interface 117 may receive a user command from the user interface (UI) 120, may receive movement information of the robot cleaner 100 from the movement detector 130, and may receive an obstacle or the like detected by the obstacle detector 140. Thereafter, the I/O interface 117 may transmit the received user command, the received movement information, and the received obstacle information to the main processor 111, the graphics processor 113, the memory 115, etc. through the data bus 119.

In addition, the I/O interface 117 may transmit various control signals generated from the main processor 111 to the UI 120, the driver 160, or the cleaner 170.

The memory 115 may temporarily store the control program and control data needed to control the robot cleaner 100, the user command received by the UI 120, the movement information detected by the movement detector 130, the obstacle position information detected by the obstacle detector 140, and various control signals generated from the main processor 111.

The memory 115 may include volatile memories such as SRAM, DRAM, or the like. However, the scope or spirit of the present disclosure is not limited thereto. If necessary, the memory 115 may include non-volatile memories, for example, a flash memory, a Read Only Memory (ROM), an Erasable Programmable Read Only Memory (EPROM), an Electrically Erasable Programmable Read Only Memory (EEPROM), etc.

In more detail, the non-volatile memory may semipermanently store control program and control data needed to control the robot cleaner 100. The volatile memory may retrieve the control program and control data from the non-volatile memory and may store the retrieved control program and control data. Alternatively, the volatile memory may store a user command received by the UI 120, movement information detected by the movement detector 130, the obstacle position information detected by the obstacle detector 140, and various control signals generated from the main processor 111.

The graphics processor 113 may convert a reflected light image acquired from the obstacle detector 140 into an image having resolution capable of being processed by the main processor 111, or may convert the reflected light image into a format capable of being processed by the main processor 111.

The main processor 111 may process data stored in the memory 115 according to the control program stored in the memory 115.

For example, the main processor 111 may process the output signals of the movement detector 130 and the obstacle detector 140, and may generate a control signal for controlling the driver 160 and the cleaner 170.

The main processor 111 may generate a traveling record on the basis of movement information of the robot cleaner 100 detected by the movement detector 130, and may store the generated traveling record in the memory 115. In addition, the main processor 111 may update map data stored in the storage 180 on the basis of the traveling record.

The main processor 111 may calculate the direction, distance, and size of the obstacle on the basis of the reflected light image acquired by the obstacle detector 140. In addition, the main processor 111 may calculate the traveling path to avoid the obstacle according to the direction, distance, and size of the obstacle, and may generate the traveling control signal to be supplied to the driver 160 in a manner that the robot cleaner 100 moves along the calculated traveling path.

As described above, the controller 110 may determine the position, movement, etc. of the robot cleaner 100 on the basis of the output signal of the movement detector 130, and may determine the position, size, etc. of the obstacle on the basis of the output signal of the obstacle detector 140.

In addition, the controller 110 may control the driver 160 in a manner that the robot cleaner 100 travels on the floor to be cleaned, and may control the cleaner 170 in a manner that the robot cleaner 100 can clean the floor to be cleaned while in motion.

The following operations of the robot cleaner 100 may be interpreted as operations caused by the control operations of the controller 110.

Although the above-mentioned embodiment has exemplarily disclosed the UI 120, the movement detector 130, the obstacle detector 140, the image acquirer 150, the driver 160, the cleaner 170, the storage 180, the communicator 190, and the controller 110 for convenience of description, the scope or spirit of the robot cleaner 100 is not limited thereto, and some constituent elements may be excluded from or added to the robot cleaner 100 as necessary.

For example, the robot cleaner 100 may further include an illumination sensor, a geomagnetic sensor, or the like.

A method for detecting the obstacle (O) using the above-mentioned obstacle detector 140 will hereinafter be described.

A method for allowing the obstacle detector 140 to recognize the presence or absence of the obstacle according to the present disclosure will hereinafter be given.

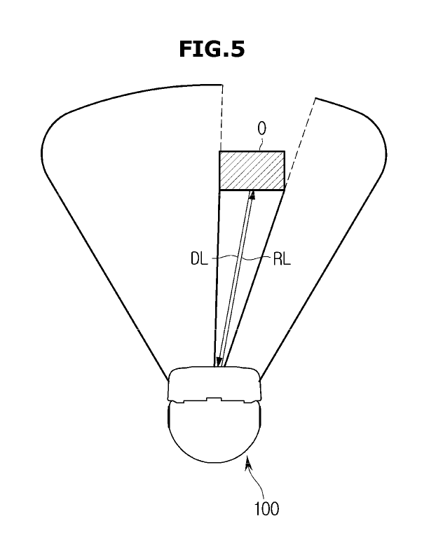

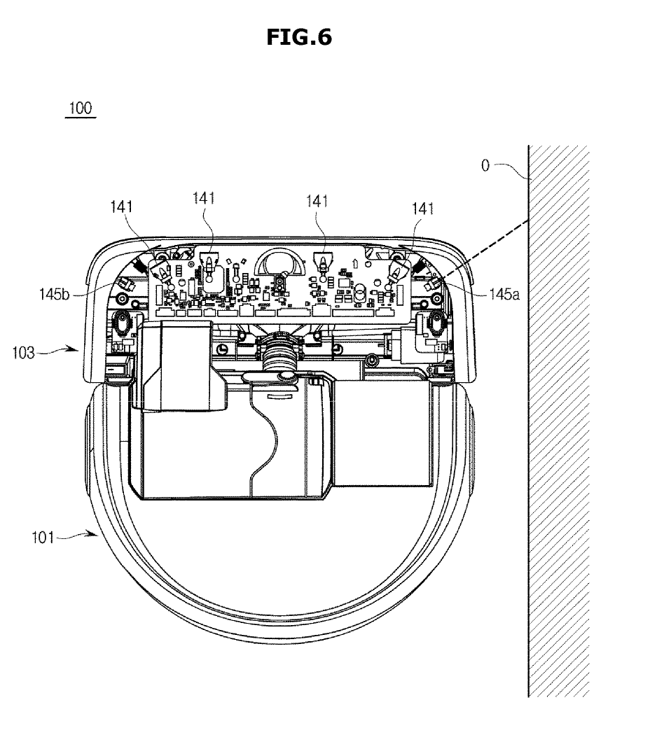

FIG. 5 is a conceptual diagram illustrating a method for allowing an obstacle detector contained in the robot cleaner to detect an obstacle located in a forward direction according to an embodiment of the present disclosure. FIG. 6 is a conceptual diagram illustrating a method for allowing an obstacle detector contained in the robot cleaner to detect an obstacle located in a side direction according to an embodiment of the present disclosure.

As described above, the obstacle detector 140 may include a forward light emission module 141, a forward light reception module 143, and a side light sensor module 145.

The forward light emission module 141 contained in the obstacle detector 140 may emit light in the traveling direction of the robot cleaner 100, and the light emitted by the forward light emission module 141 may be diffused in a fan shape as shown in FIG. 5.

If the obstacle (O) is not located in the traveling direction of the robot cleaner 100, the light (DL) emitted from the forward light emission module 141 travels in the traveling direction of the robot cleaner 100, so that the forward light reception module 143 may not receive light (RL) reflected from the obstacle (O).

In contrast, if the obstacle (O) is located in a forward direction of the robot cleaner 100, light (DL) emitted from the forward light emission module 141 will be reflected from the obstacle (O). In this case, some parts from among the reflected light (RL) reflected from the obstacle (O) may be directed to the forward light reception module 143 of the robot cleaner 100.

The reflected light (RL) proceeding to the forward light reception module 143 may be reflected from the reflective mirror 143a, and the image sensor 143b may receive the reflected light reflected from the reflective mirror 143a.

In this case, since the light emitted from the forward light emission module 141 is parallel to the floor to be cleaned, light reflected from the obstacle (O) may have a line shape. In other words, the light reflected from the obstacle (O) may form a line image on the reflective mirror 143a.

The image sensor 143a may output image data indicating the length and position of the line image formed on the reflective mirror 143a to the controller 110, and the controller 110 may determine the size and position (direction and distance) of the obstacle on the basis of the image data.

As described above, the robot cleaner 100 may calculate the direction and distance of the obstacle (O) on the basis of the image acquired by the image sensor 143b.

The side light sensor module 145 may emit linear light in a side direction of the robot cleaner 100 as shown in FIG. 6, and may receive light reflected from the obstacle (O) located in a side direction of the robot cleaner 100.

In addition, the side light sensor module 145 may provide reception data of the reflected light to the controller 110, and the controller 110 may calculate the distance between the robot cleaner 100 and the obstacle (O) on the basis of the reception data of the reflected light.

For example, the side light sensor module 145 may transmit information regarding the intensity of the received reflected light to the controller 110, and the controller 110 may calculate the distance between the robot cleaner 100 and the obstacle (O) on the basis of the reflected-light intensity.

In another example, the side light sensor module 145 may transmit a time of flight (TOF) difference between the emitted light and the received reflected light to the controller 110, and the controller 110 may calculate the distance between the robot cleaner 100 and the obstacle (O) on the basis of the TOF value.

In another example, the side light sensor module 145 may transmit the distance between the emission position of the emitted light and the reception position of the reflected light to the controller 110. The controller 110 may calculate the distance between the robot cleaner 100 and the obstacle (O) on the basis of the distance between the light emission position and the light reception position.

As described above, the robot cleaner 100 may determine the size and position of the obstacle (O) through light, radio waves, sonic waves (ultrasonic waves), etc.

The above-mentioned embodiment has disclosed the robot cleaner 100.

A method for generating map data and the operations of the robot cleaner 100 will hereinafter be described.

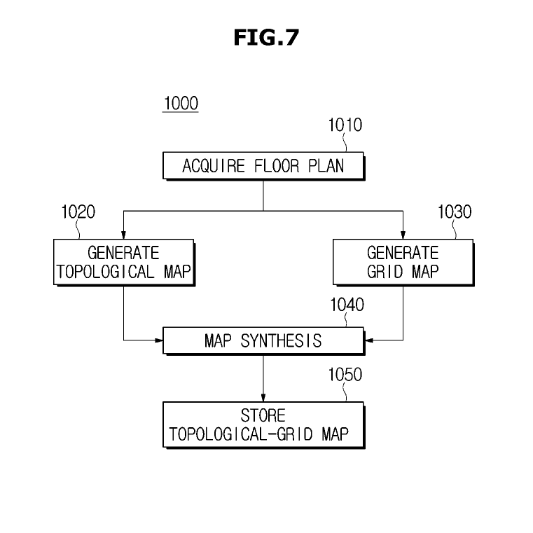

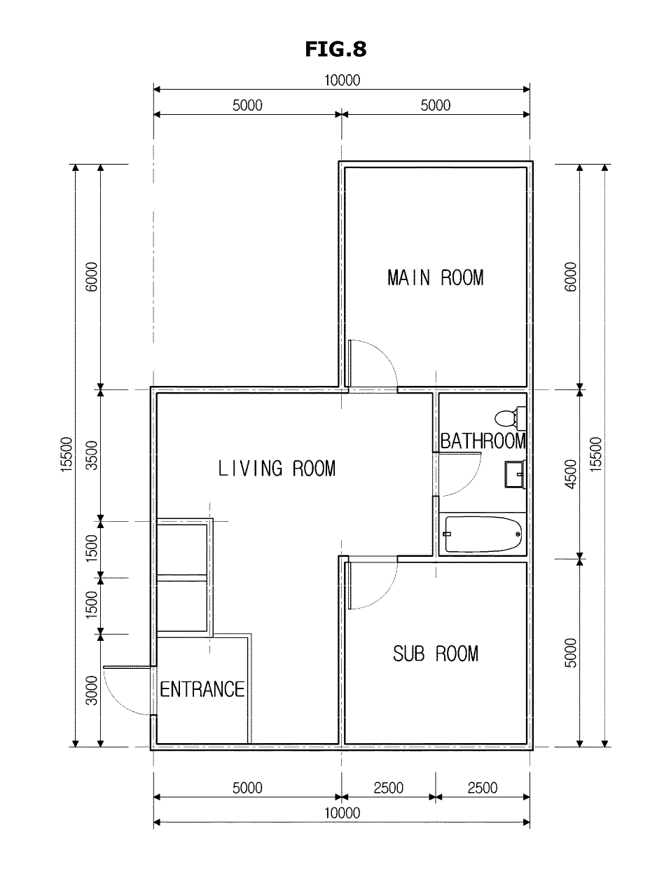

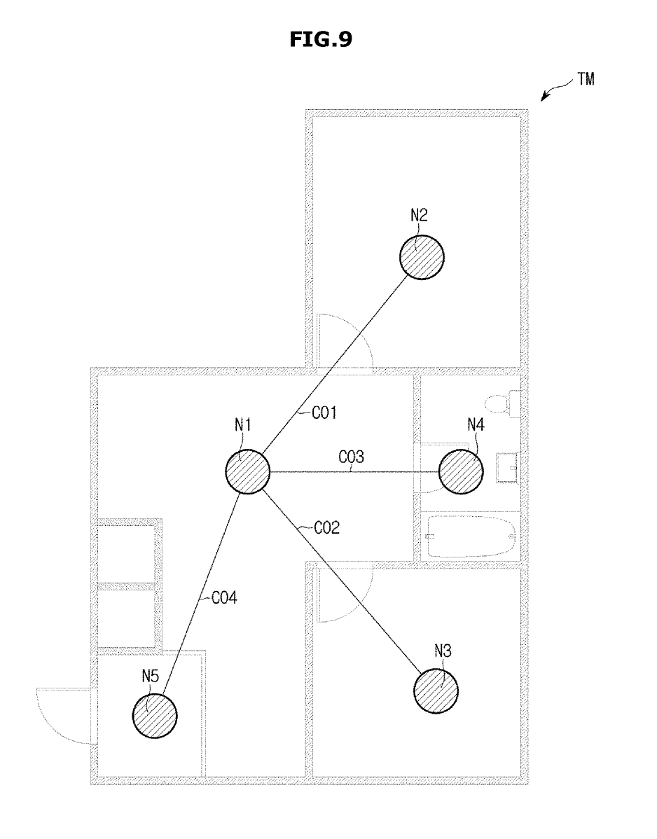

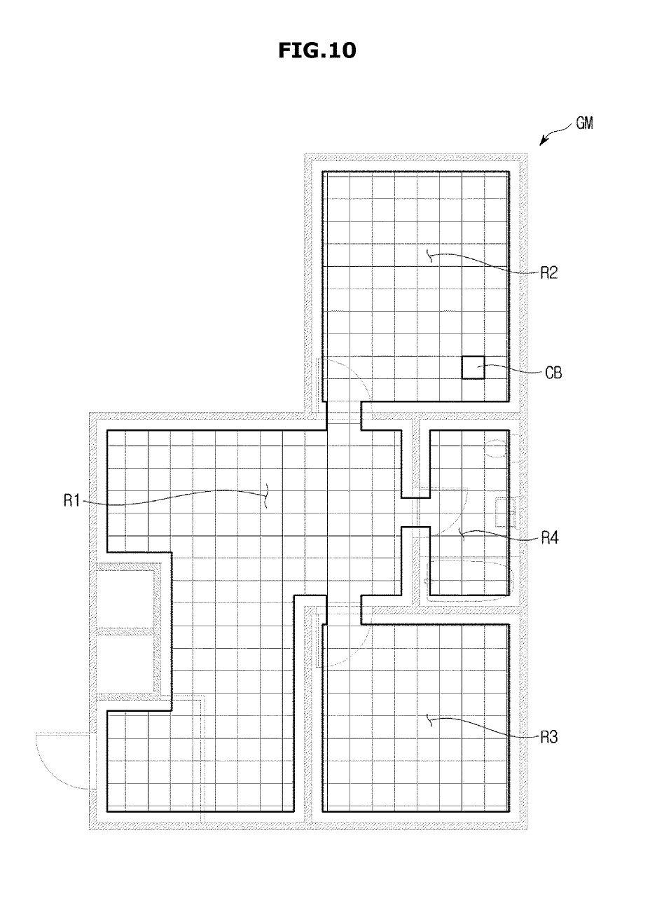

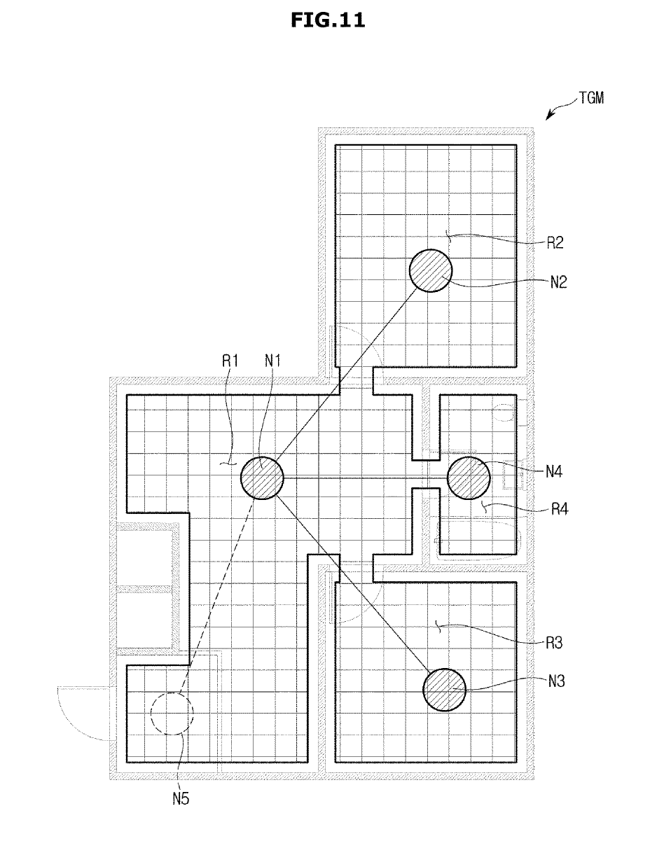

FIG. 7 is a flowchart illustrating a method for generating map data according to an embodiment of the present disclosure. FIG. 8 illustrates an example of a floor plan (FP) indicating a plan view. FIG. 9 is a view illustrating a topological map generated by the map data generation method shown in FIG. 7 on the basis of the FP shown in FIG. 8. FIG. 10 is a view illustrating a grid map generated by the map data generation method shown in FIG. 7 on the basis of the FP of FIG. 8. FIG. 11 is a view illustrating a topological-grid map generated by the map data generation method shown in FIG. 7 on the basis of the FP of FIG. 8.

The map data generation method 1000 will hereinafter be described with reference to FIGS. 7 to 11.

The map data generation method 1000 may be carried out by a manufacturer of the robot cleaner 100 or by the robot cleaner 100. In other words, the manufacturer of the robot cleaner 100 may generate map data regarding the cleaning space of the user upon receiving a user request during a sales process of the robot cleaner 100, and may store the generated map data in the robot cleaner 100. Alternatively, during the initialization operation before the robot cleaner initially travels in the user's cleaning space, the robot cleaner 100 may generate map data regarding the user's cleaning space.

First, a floor plan (FP) indicating a plan view of the cleaning space is obtained in operation 1010.

The FP of the cleaning space may be obtained in various ways.

For example, the robot cleaner 100 or the manufacturer of the robot cleaner 100 may obtain the floor plan (FP) of the cleaning space from the external server over a wide area network (WAN) such as the Internet.

In recent times, construction developers, real-estate agents, or public institutions have disclosed various floor plans (FPs) regarding residential spaces (houses or apartments), business spaces (efficiency apartment called officetel), and public spaces, etc. on their Internet homepages or the like.

The manufacturer of the robot cleaner 100 may acquire user address information from the user, and may download the floor plan (FP) opened to the wide area network (WAN) such as the Internet on the basis of the acquired address information.

In addition, the robot cleaner 100 may access the Internet through the communicator 190, and may download the floor plan (FP) of the cleaning space from a user-designated Internet site.

In another example, the robot cleaner 100 or the manufacturer of the robot cleaner 100 may directly acquire the floor plan (FP) from the user.

The manufacturer of the robot cleaner 100 may directly receive the floor plan formed in an image file from the user.

The robot cleaner 100 may receive the image-file-shaped floor plan (FP) from the user equipment (UE) through the communicator 190.

The floor plan (FP) may include a large amount of information regarding the cleaning space of the user.

For example, the floor plan (FP) may include a geometrical structure of the cleaning space as shown in FIG. 8. In other words, the floor plan (FP) may display information regarding arrangement of walls and entrances, information regarding the size of each cleaning space, and the sizes of respective cleaning regions (a living room, a main room, a sub room, a bathroom, a front entrance, etc.) using letters, numbers, symbols, images, or the like.

In addition, the floor plan (FP) may include not only information regarding the cleaning regions (a living room, a main room, a sub room, a bathroom, a front entrance, etc.) contained in the cleaning space, but also information regarding connectivity between the cleaning regions (a living room, a main room, a sub room, a bathroom, a front entrance, etc.). In other words, letters, numbers, or symbols indicating the cleaning regions (a living room, a main room, a sub room, a bathroom, a front entrance, etc.) divided by walls may be displayed on the floor plan (FP), and the entrance to interconnect the cleaning regions (a living room, a main room, a sub room, a bathroom, a front entrance, etc.) may be displayed as an image on the floor plan (FP).

Although the floor plans (FPs) regarding the residential spaces (e.g., houses or apartments) are exemplarily shown in FIG. 8, the scope of the present disclosure is not limited to the floor plan (FP) of the residual spaces.

For example, the floor plan (FP) obtained by the robot cleaner 100 or the floor plan (FP) obtained by the manufacturer of the robot cleaner 100 may be a floor plan (FP) of the office area or a floor plan (FP) of the public space. The floor plan (FP) of the office area may include an office, a conference room, an office pantry, a warehouse, a resting room, a laboratory, etc. In addition, the floor plan (FP) of the public area may include a working place, a walk space, a rest area, stairs, a bathroom, etc.

The robot cleaner 100 or the manufacturer of the robot cleaner 100 may generate map data on the basis of the floor plan (FP) including the above-mentioned information.

Thereafter, the topological map (TM) is generated in operation 1020, and the grid map (GM) is generated in operation 1030.

In this case, the topological map (TM) and the grid map (GM) may be sequentially or independently generated.

As described above, the topological map (TM) may indicate connectivity between the plurality of cleaning regions or the plurality of objects (obstacles).

A plurality of cleaning nodes (N1, N2, N3, N4, N5) configured to construct the topological map (TM) may be extracted from the floor plan (FP).

For example, referring to the floor plan (FP) including the cleaning spaces represented by letters indicating a living room, a main room, a sub room, a bathroom, and an entrance as shown in FIG. 8, a first cleaning node N1 indicating the living room, a second cleaning node N2 indicating the main room, a third cleaning node N3 indicating a sub room, a fourth cleaning node N4 indicating the bathroom, and a fifth cleaning node N5 indicating the entrance may be extracted from the FP of FIG. 9.

As a result, the topological map (TM) may include a first cleaning node N1, a second cleaning node N2, a third cleaning node N3, a fourth cleaning node N4, and a fifth cleaning node N5.

In addition, connectivity between the plurality of cleaning nodes (N1, N2, N3, N4, N5) may be determined on the basis of the floor plan (FP).

For example, as shown in FIG. 9, a first connection (CO1) for interconnecting the first cleaning node N1 and the second cleaning node N2, a second connection (CO2) for interconnecting the first cleaning node N1 and the third cleaning node N3, a third connection (CO3) for interconnecting the first cleaning node N1 and the fourth cleaning node N4, and a fourth connection (CO4) for interconnecting the first cleaning node N1 and the fifth cleaning node N5 may be determined on the basis of the FP.

As a result, the topological map (TM) may include connectivity relationships (CO1, CO2, CO3, CO4) among the first cleaning node N1, the second cleaning node N2, the third cleaning node N3, the fourth cleaning node N4, and the fifth cleaning node N5.

As described above, the topological map (TM) may represent the respective cleaning regions and the connectivity relationships among the cleaning regions as shown in the FR

In addition, the grid map (GM) may represent the cleaning space by performing spatial decomposition of the cleaning space.

For example, according to the floor plan (FP) of the cleaning space including a living room, a main room, a sub room, a bathroom, and an entrance as shown in FIG. 8, the grid map (GM) may include the entire outline of the cleaning space and the plurality of cleaning blocks (CBs) acquired when the cleaning space is divided into a plurality of predetermined-sized blocks.

In addition, the grid map (GM) may divide the cleaning space into a plurality of cleaning regions (R1, R2, R3, R4) as necessary. For example, the grid map (GM) may divide the floor plan (FP) indicating the cleaning space into a first cleaning region R1 indicating a living room, a second cleaning region R2 indicating a main room, a third cleaning region R3 indicating a sub room, and a fourth cleaning region R4 indicating a bathroom. In addition, each of the cleaning regions (R1, R2, R3, R4) may be classified into a plurality of cleaning blocks (CBs).

As a result, the grid map (GM) may divide the cleaning space into the plurality of cleaning regions (R1, R2, R3, R4) and the plurality of cleaning blocks (CBs).

As described above, the grid map (GM) may represent geometrical structures of the cleaning regions shown in the floor plan (FP) and information of a specific position contained in the cleaning regions.

As described above, the robot cleaner 100 or the manufacturer of the robot cleaner 100 may independently generate the topological map (TM) and the grid map (GM) on the basis of the floor plan (FP).

A detailed method for forming the topological map (TM) and the grid map (GM) will hereinafter be described.

Thereafter, the topological map (TM) and the grid map (GM) are synthesized in operation 1040.

As described above, the topological map (TM) may include the respective cleaning regions contained in the cleaning space and connectivity between the cleaning regions. The grid map (GM) may include information regarding the external shape of the cleaning space and position information such as coordinates of a specific position contained in the cleaning space.

As described above, the topological map (TM) and the grid map (GM) are complementary to each other. If the topological map (TM) and the grid map (GM) are synthesized, the robot cleaner 100 may recognize connectivity between the cleaning regions and position information of the cleaning space.

Synthesis of the topological map (TM) and the grid map (GM) may be achieved by mapping the plurality of cleaning nodes (N1, N2, N3, N4, N5) contained in the topological map (TM) to the plurality of cleaning regions (R1, R2, R3, R4) contained in the grid map (GM).

For example, as shown in FIG. 11, the first cleaning node N1 of the topological map (TM) may be mapped to the first cleaning region R1 of the grid map (GM), the second cleaning node N2 of the topological map (TM) may be mapped to the second cleaning region R2 of the grid map (GM), the third cleaning node N3 of the topological map (TM) may be mapped to the third cleaning region R3 of the grid map (GM), and the fourth cleaning node N4 of the topological map (TM) may be mapped to the fourth cleaning region R4 of the grid map (GM). In this case, the fifth cleaning node N5 not mapped to the cleaning regions (R1, R2, R3, R4) may be deleted.

The above-mentioned mapping operation of the plurality of cleaning nodes (N1, N2, N3, N4) and the plurality of cleaning regions (R1, R2, R3, R4) may be achieved through the medium of the FP.

In more detail, the plurality of cleaning nodes (N1, N2, N3, N4) may be mapped to the plurality of cleaning regions (R1, R2, R3, R4) on the basis of not only coordinates obtained when the plurality of cleaning nodes (N1, N2, N3, N4) are extracted from the floor plan (FP), but also other coordinates obtained when the plurality of cleaning regions (R1, R2, R3, R4) are extracted from the floor plan (FP).

For example, the first cleaning node N1 of the topological map (TM) is extracted from the letters “Living Room” shown in the first cleaning region R1 of the grid map (GM), such that the first cleaning node N1 may be mapped to the first cleaning region R1.

The second cleaning node N2 of the topological map (TM) is extracted from the letters “Main Room” shown in the second cleaning region R2 of the grid map (GM), such that the second cleaning node N2 may be mapped to the second cleaning region R2.

The third cleaning node N3 of the topological map (TM) is extracted from the letters “Sub Room” shown in the third cleaning region R3 of the grid map (GM), such that the third cleaning node N3 may be mapped to the third cleaning region R3.

The fourth cleaning node N4 of the topological map (TM) is extracted from the letters “Bathroom” shown in the fourth cleaning region R4 of the grid map (GM), such that the fourth cleaning node N4 may be mapped to the fourth cleaning region R4.

As a result, the topological map (TM) and the grid map (GM) may be synthesized as shown in FIG. 11.

Although the plurality of cleaning nodes (N1, N2, N3, N4) of the topological map overlap with the plurality of cleaning regions (R1, R2, R3, R4) of the grid map (GM) as shown in FIG. 11, the scope of the present disclosure is not limited thereto, and the plurality of cleaning nodes (N1, N2, N3, N4) may be stored in association with the plurality of cleaning regions (R1, R2, R3, R4). For example, a lookup table (LUT) for mapping the plurality of cleaning nodes (N1, N2, N3, N4) to the plurality of cleaning regions (R1, R2, R3, R4) may be independently provided.

Thereafter, a topological-grid map (TGM) in which the topological map (TM) and the grid map (GM) are synthesized may be stored in operation 1050.

The topological-grid map (TGM) may be achieved by synthesizing the topological map (TM) and the grid map (GM), and may represent the plurality of cleaning regions contained in the cleaning space, connectivity between the plurality of cleaning regions, and position information of the plurality of cleaning regions.

The robot cleaner 100 or the manufacturer of the robot cleaner 100 may store the topological-grid map (TGM) in the storage 180 of the robot cleaner 100. For example, the robot cleaner 100 or the manufacturer of the robot cleaner 100 may store map data indicating the topological-grid map (TGM) in the storage 180 of the robot cleaner 100.

As described above, the topological-grid map (TGM) may be stored in the robot cleaner 100 before the robot cleaner 100 initially travels in the cleaning space of the user. The topological-grid map (TGM) may include the plurality of cleaning regions contained in the cleaning space, connectivity between the plurality of cleaning regions, and position information of the plurality of cleaning regions.

A method for forming the topological map (TM) on the basis of the floor plan (FP) will hereinafter be described.

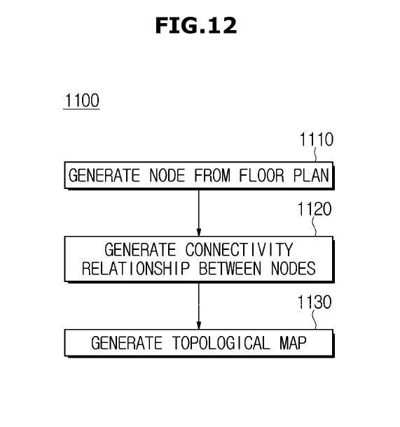

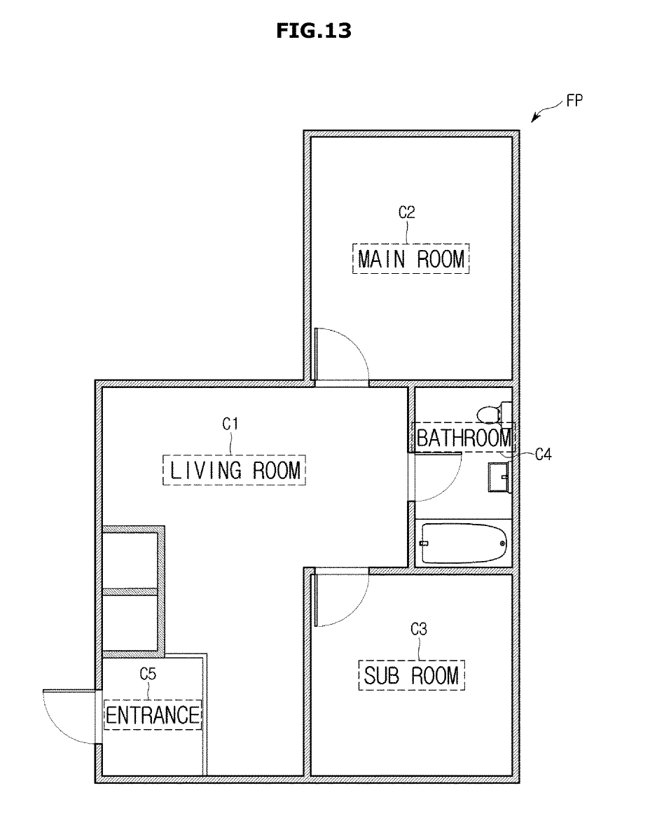

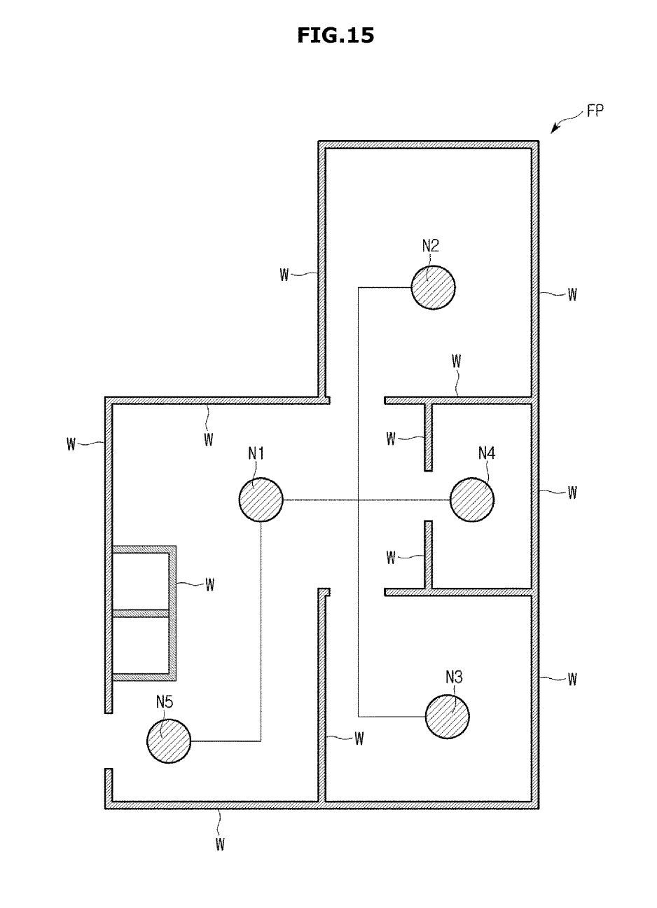

FIG. 12 is a flowchart illustrating a method for generating a topological map according to an embodiment of the present disclosure. FIG. 13 is a view illustrating letter regions extracted by the topological map generation method of FIG. 12. FIG. 14 is a view illustrating walls (W) extracted by the topological map generation method of FIG. 12. FIG. 15 is a view illustrating the shortest path between a plurality of cleaning nodes generated by the topological map generation method of FIG. 12.

The topological map (TM) generation method 1100 will hereinafter be described with reference to FIGS. 12 to 15.

The topological map (TM) generation method 1100 to be described will be carried out by the manufacturer of the robot cleaner 100 or by the robot cleaner 100. In other words, the manufacturer of the robot cleaner 100 may generate map data regarding the user's cleaning space according to a user request during the sales process of the robot cleaner 100, and may be stored in the robot cleaner 100. Alternatively, the robot cleaner 100 may generate map data regarding the user's cleaning space during the initialization process before the robot cleaner 100 initially travels in the user's cleaning space.

First, the plurality of cleaning nodes (N1, N2, N3, N4, N5) may be generated from the floor plan (FP) in operation 1110.

The plurality of cleaning nodes (N1, N2, N3, N4, N5) indicating the plurality of cleaning regions (R1, R2, R3, R4) may be generated in various ways.

For example, the plurality of cleaning nodes (N1, N2, N3, N4, N5) may be generated from letters shown in the floor plan (FP).

As can be seen from FIG. 8, names indicating the respective cleaning regions are generally displayed on the floor plan (FP). For example, the living room, the main room, the sub room, the bathroom, and the front entrance may be displayed on the floor plan (FP).

The letters marked on the floor plan (FP) indicate the cleaning regions contained in the cleaning space, such that the plurality of cleaning nodes corresponding to the plurality of letters marked on the floor plan (FP) may be generated.

In order to generate the plurality of cleaning nodes, the letter region including letters may first be extracted from the floor plan (FP).

The letter region may be extracted using various algorithms.

For example, letters may be extracted from the floor plan (FP) using a letter region extraction algorithm such as a morphology operation algorithm. In more detail, letters or symbols contained in the floor plan (FP) are represented by fine lines (thin lines), such that the letter region can be extracted from the floor plan (FP).

In more detail, dilation operation and erosion operation may be performed on the floor plan (FP). By the dilation and erosion operations regarding white color, letters or symbols, each of which is composed of fine lines, may be deleted from the floor plan (FP).

Thereafter, an image subtraction operation may be performed on the floor plan (FP) and the image from which letters and symbols are deleted. By the image subtraction operation, the fine-line image composed of letters or symbols may be acquired.

In this case, the image acquired by the image subtraction operation may include not only letters and symbols but also noise. Therefore, in order to remove noise, labeling of the image acquired by the image subtraction operation may be performed.

Thereafter, a label having letter characteristics may remain, and the remaining labels may be removed, such that noise other than the letters and symbols can be removed.

Thereafter, the letter region may be extracted by clustering regarding the image on which letters or symbols are displayed. For example, a first letter region C1 including “Living Room”, a second letter region C2 including “Main Room”, a third letter region C2 including “Sub Room”, a fourth letter region C4 including “Bathroom”, and a fifth letter region C5 including “Front Entrance” may be extracted as shown in FIG. 13.

Thereafter, the cleaning node corresponding to the extracted letter region may be generated. For example, the first cleaning node N1 corresponding to the first letter region C1, the second cleaning node N2 corresponding to the second letter region C2, the third cleaning node N3 corresponding to the third letter region C3, the fourth cleaning node N4 corresponding to the fourth letter region C4, and the fifth cleaning node N5 corresponding to the fifth letter region C5 may be generated.

In another example, letters may be extracted from the floor plan (FP) through machine learning regarding letter shapes, or letters may be extracted from the floor plan (FP) through image processing such as edge detection. In addition, the manufacturer or user of the robot cleaner 100 may also directly select a desired letter region.

In addition, letters contained in the extracted letter region may be recognized in a manner that names of the cleaning regions can be recognized. According to the result of such letter recognition, the robot cleaner 100 may recognize names of the cleaning regions spoken by the user.

For example, the living room corresponding to the first cleaning node N1, the main room corresponding to the second cleaning node N2, the sub room corresponding to the third cleaning node N3, the bathroom corresponding to the fourth cleaning node N4, and the front entrance corresponding to the fifth cleaning node N5 may be recognized.

Thereafter, the connectivity relationships (CO1, CO2, CO3, CO4) among the plurality of cleaning nodes (N1, N2, N3, N4, N5) may be generated in operation 1120.

The connectivity relationships (CO1, CO2, CO3, CO4) among the plurality of cleaning nodes (N1, N2, N3, N4, N5) may indicate paths through which the robot cleaner 100 can move among the cleaning regions (R1, R2, R3, R4).

Therefore, if the paths among the cleaning regions (R1, R2, R3, R4) are generated, connectivity relationships (CO1, CO2, CO3, CO4) among the plurality of cleaning nodes (N1, N2, N3, N4) may be generated.

In order to generate the path among the cleaning regions (R1, R2, R3, R4), the floor plan (FP) may be classified into a first region to which the robot cleaner 100 can move and a second region to which the robot cleaner 100 does not move.

In other words, walls (Ws) to which the robot cleaner 100 does not move may be extracted from the floor plan (FP).

The walls (Ws) may be extracted from the floor plan (FP) in various ways.

For example, the walls (Ws) may be extracted from the floor plan (FP) using the morphology operation algorithm. In more detail, each wall (VV) of the floor plan (FP) may be denoted by a thick line (bold line), such that each wall (W) may be extracted from the floor plan (FP).

Dilation operation and erosion operation may be performed on the floor plan (FP). By the dilation operation and the erosion operation regarding the white color, a fine line (thin line) may be deleted from the floor plan (FP).

As a result, the image including bold-lined walls (Ws) may be extracted from the floor plan (FP) as shown in FIG. 14.

Thereafter, the path among the cleaning regions (R1, R2, R3, R4) may be generated on the basis of the image indicating the walls.

In order to generate the path among the plurality of cleaning regions (R1, R2, R3, R4), the shortest path among the plurality of letter regions (C1, C2, C3, C4, C5) may be calculated. Since the letter regions (C1, C2, C3, C4, C5) respectively represent the cleaning regions (R1, R2, R3, R4), the shortest path among the plurality of letter regions (C1, C2, C3, C4, C5) may indicate the path among the plurality of cleaning regions (R1, R2, R3, R4).

The shortest path among the plurality of letter regions (C1, C2, C3, C4, C5) may be calculated in various ways.

For example, the shortest path between the plurality of letter regions (C1, C2, C3, C4, C5) may be calculated using the A-star (A*) algorithm.

The A* algorithm is a kind of graph/tree search algorithms designed to search for the shortest path from a departure to a destination.

In more detail, according to the A* algorithm, a heuristic estimation value H(x) indicating a rank value for estimating the best path passing through each place (each point) may be calculated, and the best path is searched for on the basis of the calculated heuristic estimation value H(x).

For example, if the shortest path from the first cleaning node N1 to the second cleaning node N2 is searched for, the heuristic estimation value H(x) regarding all points connected or adjacent to the first cleaning node N1 may be calculated, and any one point connected or adjacent to the first cleaning node N1 may be selected on the basis of the calculated heuristic estimation value H(x).

In addition, the heuristic estimation values H(x) regarding all points connected or adjacent to the selected point may be calculated, and any one point connected or adjacent to the selected point may be selected on the basis of the calculated heuristic estimation value H(x).

By repetition of the above-mentioned operations, the shortest path from the first cleaning node N1 to the second cleaning node N2 may be searched for.

The A* algorithm may be represented by the following equation 1.

F(x)=G(x)+H(x) [Equation 1]

In Equation 1, F(x) may denote an estimation function at a point X, G(x) may denote costs from the departure point to the point X, and H(x) may denote costs from the point X to the destination point.

The shortest distance among the plurality of cleaning nodes (N1, N2, N3, N4, N5) may be calculated using the A* algorithm.

For example, according to the A* algorithm, as shown in FIG. 15, the shortest path (CO1) between the first cleaning node N1 and the second cleaning node N2, the shortest path (CO2) between the first cleaning node N1 and the third cleaning node N3, the shortest path (CO3) between the first cleaning node N1 and the fourth cleaning node N4, and the shortest path (CO4) between the first cleaning node N1 and the fifth cleaning node N5 may be generated as shown in FIG. 15.

Although the shortest path from the first cleaning node N1 to each of the second cleaning node N2, the third cleaning node N3, the fourth cleaning node N4, and the fifth cleaning node N5 has been exemplarily searched for as shown in FIG. 15, the scope of the present disclosure is not limited thereto, and the shortest path among all the cleaning nodes (N1, N2, N3, N4, N5) may also be searched for.

In addition, the cost (i.e., distance) among the cleaning nodes (N1, N2, N3, N4, N5) may be calculated using the A* algorithm. Since the A* algorithm calculates the estimation function value at the point X, the estimation function value at the target point may be the cost (i.e., distance) from the departure point to the destination point.

For example, the distance of the shortest path (CO1) between the first cleaning node N1 and the second cleaning node N2 may be defined as the cost between the first cleaning node N1 and the second cleaning node N2. The distance of the shortest path (CO2) between the first cleaning node N1 and the third cleaning node N3 may be defined as the cost between the first cleaning node N1 and the third cleaning node N3. In addition, the distance of the shortest path (CO3) between the first cleaning node N1 and the fourth cleaning node N4 may be defined as the cost between the first cleaning node N1 and the fourth cleaning node N4.

The distance of the shortest path (CO4) between the first cleaning node N1 and the fifth cleaning node N5 may be defined as the cost between the first cleaning node N1 and the fifth cleaning node N5.

The cost between the cleaning nodes may be used to search for the shortest path when the robot cleaner 100 moves among the cleaning regions (R1, R2, R3, R4) in a subsequent procedure.

In addition, symbols (or the like) misunderstood as the cleaning nodes may be excluded according to the A* algorithm. In more detail, the cleaning node at which the shortest path is not searched for according to the A* algorithm may be deleted, and the deleted cleaning node may correspond to any of symbols marked on the FR

The shortest path among the plurality of cleaning nodes (N1, N2, N3, N4, N5) can be searched for not only using the A* algorithm but also using the Dijkstra algorithm or the Best-First Search (BFS) algorithm.

Thereafter, the path among the plurality of cleaning nodes (N1, N2, N3, N4, N5) may be simplified.

In order to generate connectivity relationship among the plurality of cleaning nodes (N1, N2, N3, N4, N5), the path among the plurality of cleaning nodes (N1, N2, N3, N4, N5) may be simplified, and connectivity relationship among the plurality of cleaning nodes (N1, N2, N3, N4, N5) may be generated on the basis of the simplified path among the plurality of cleaning nodes (N1, N2, N3, N4, N5).

Thereafter, the generated topological map (TM) may be stored in operation 1130.

As described above, the plurality of cleaning nodes (N1, N2, N3, N4, N5) may be generated using letters, numbers, symbols, or images displayed on the FP, and connectivity relationships (CO1, CO2, CO2, CO4) among the plurality of cleaning nodes (N1, N2, N3, N4, N5) may be generated using an image indicating the walls (W). As a result, the topological map (TM) indicating the plurality of cleaning nodes (N1, N2, N3, N4, N5) and the connectivity relationships (CO1, CO2, CO2, CO4) among the plurality of cleaning nodes (N1, N2, N3, N4, N5) may be acquired. In this case, not all the cleaning nodes (N1, N2, N3, N4, N5) contained in the topological map (TM) are reflected in the topological-grid map (TGM). That is, the node N5 not mapped to the plurality of cleaning regions (R1, R2, R3, R4) contained in the grid map (GM) may be deleted.

The robot cleaner 100 or the manufacturer of the robot cleaner 100 may store the topological map (TM) in the storage 180 of the robot cleaner 100. For example, the robot cleaner 100 or the manufacturer of the robot cleaner 100 may store map data indicating the topological map (TM) in the storage 180 of the robot cleaner 100.

As described above, the topological map (TM) may be stored in the robot cleaner 100 before the robot cleaner 100 initially travels about the cleaning space of the user, and the topological map (TM) may include the plurality of cleaning nodes indicating the plurality of cleaning regions contained in the cleaning space and the connectivity relationships among the plurality of cleaning nodes.

Although the above-mentioned embodiment has exemplarily disclosed the method for generating the topological map (TM) by extracting letters from the floor plan (FP), the topological map (TM) generation method is not limited to the method for extracting letters from the floor plan (FP). For example, in order to acquire the topological map (TM), the Voronoi diagram, in which the edge of the floor plan (FP) is extracted and a specific point at which the extracted edge is evenly divided into a plurality of sections is determined to be the cleaning node, may be used. Alternatively, the floor plan (FP) is divided into a plurality of cells and the respective divided cells are clustered, such that the topological map (TM) can be acquired.

A method for generating the grid map (GM) on the basis of the floor plan (FP) will hereinafter be described.

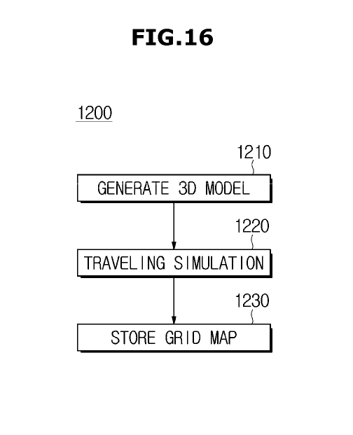

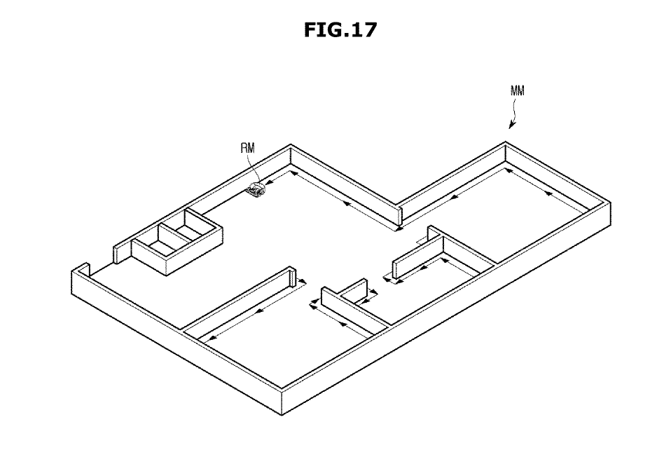

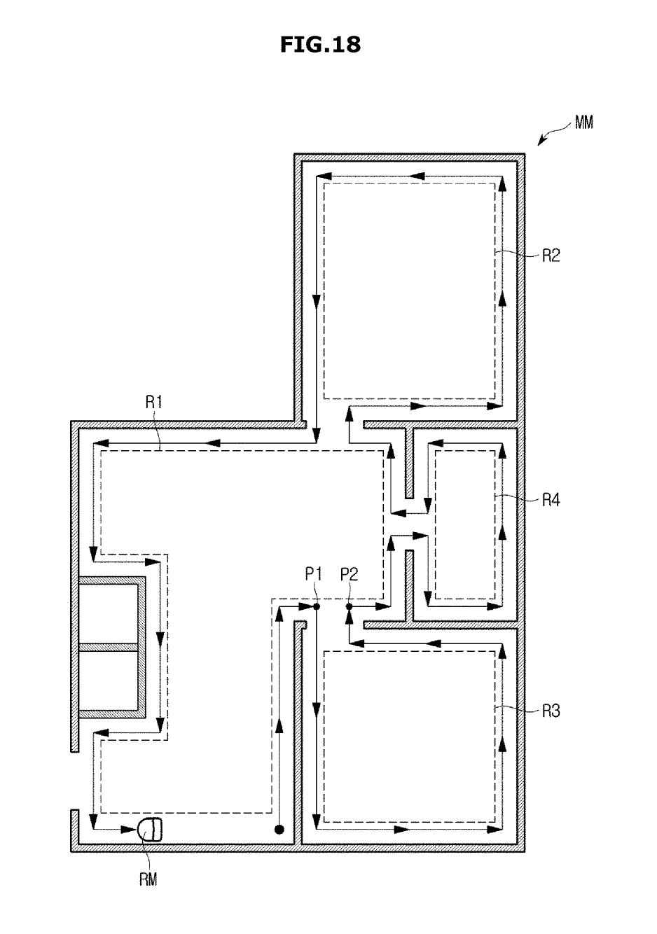

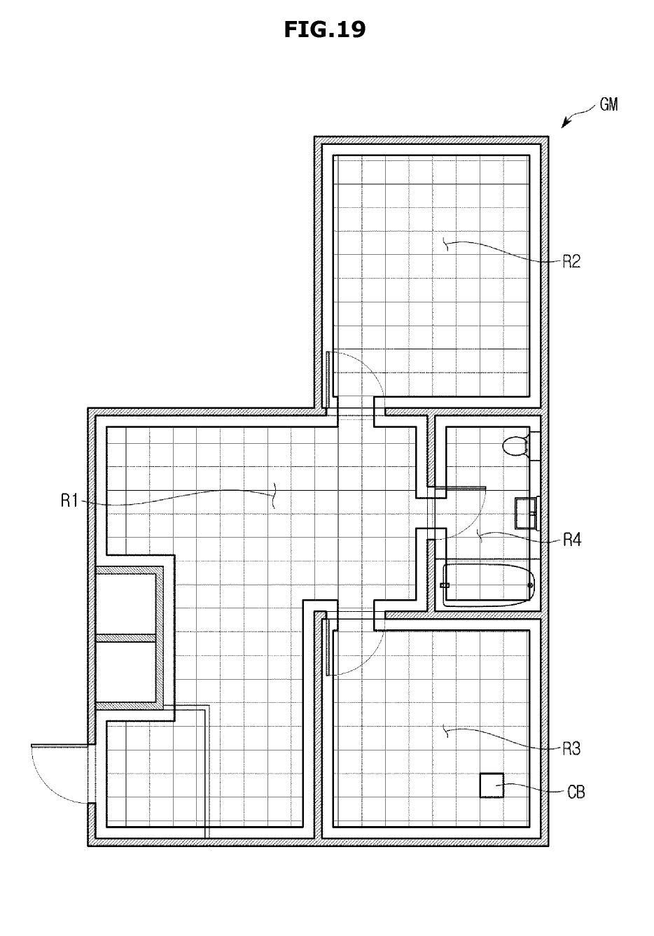

FIG. 16 is a flowchart illustrating a method for generating a grid map according to an embodiment of the present disclosure. FIG. 17 is a view illustrating a three-dimensional (3D) spatial model generated by the grid map generation method of FIG. 16. FIG. 18 is a view illustrating that a virtual robot cleaner travels according to the grid map generation method of FIG. 16. FIG. 19 is a view illustrating a grid map generated by the grid map generation method of FIG. 16.

The grid map (GM) generation method 1200 will hereinafter be described with reference to FIGS. 16 to 19.

The grid map (GM) generation method 1200 may be carried out by the robot cleaner 100 or the manufacturer of the robot cleaner 100. In other words, the manufacturer of the robot cleaner 100 may generate map data regarding the user's cleaning space upon receiving a request from the user during the sales process of the robot cleaner 100, and may store the generated map data in the robot cleaner 100. Alternatively, during the initialization operation before the robot cleaner 100 initially travels in the user's cleaning space, the robot cleaner 100 may generate map data regarding the user's cleaning space.

First, a 3D spatial model (MM) and a 3D robot model (RM) may be generated from the floor plan (FP) in operation 1210.

The 3D spatial model (MM) may be generated with the same scale as in the actual cleaning space on the basis of the actual measurement value displayed on the floor plan (FP). In more detail, the actual measurement values of the cleaning space may be acquired on the basis of letters, numbers, symbols or images extracted from the floor plan (FP).

In addition, the part denoted by Win the floor plan (FP) may be modeled as a three-dimensional (3D) wall on the basis of the actual measurement values of the cleaning space, and the part denoted by the front entrance in the floor plan (FP) may be modeled as a 3D entrance.

For example, the 3D spatial model (MM) shown in FIG. 17 may be generated by 3D modeling the floor plan (FP) of FIG. 8.

In order to generate a more simplified 3D spatial model (MM), the image indicating the wall (W) may be used.

As described above, through the dilation operation and the erosion operation for the floor plan (FP), the image indicating the wall (W) may be acquired from the floor plan (FP). In addition, the simplified 3D spatial model (MM) may be generated from the image indicating the wall (W).

The 3D robot model (RM) may also be generated with the same scale as in the actual robot cleaner 100. In more detail, the 3D robot model (RM) may be generated on the basis of the actual measurement values obtained from the robot cleaner 100.

In addition, the 3D robot model (RM) may be generated in a manner that the 3D robot model (RM) can travel along the same traveling path as in the robot cleaner 100.

For example, the 3D robot model (RM) may include a virtual user interface (UI), a movement detector, an obstacle detector, a driver, a cleaner, a storage, a communicator, and a controller. In addition, the 3D robot model (RM) may control the driver according to output signals of the movement detector and the obstacle detector, and may store the traveling record in the storage during traveling of the robot cleaner 100.

Thereafter, the traveling simulation may be carried out using the 3D spatial model (MM) and the 3D robot model (RM) in operation 1220.

In other words, the 3D robot model (RM) may automatically travel in the 3D spatial model (MM).

For example, the 3D robot model (RM) may perform wall tracing traveling in a manner that the 3D robot model (RM) can travel in all regions of the 3D spatial model (MM) indicating the cleaning space.

According to the wall tracing traveling, the 3D robot model (RM) may travel in the 3D spatial model (MM) while simultaneously maintaining a constant distance from the wall (W) as shown in FIG. 18.

In addition, the 3D robot model (RM) may store the traveling record while traveling in the 3D spatial model (MM). The traveling record written during the wall tracing traveling may have the same shape as in the cleaning space as shown in FIG. 18.

In more detail, if the 3D robot model (RM) arrives at the departure point during the wall tracing traveling, the traveling record of the 3D robot model (RM) may form a closed loop. In addition, the closed loop based on the traveling record may have the same shape as in the cleaning space.

Therefore, the grid map (GM) of the cleaning space may be generated on the basis of the traveling record of the 3D spatial model (MM).

In more detail, the closed loop based on the traveling record may be classified into a plurality of cleaning regions (R1, R2, R3, R4) as shown in FIG. 19.

In more detail, the closed loop based on the traveling record may be classified into the plurality of cleaning regions (R1, R2, R3, R4). Two points having opposite traveling directions may be searched for within a predetermined distance corresponding to the entrance size (e.g., 80 cm to 110 cm) during the traveling record time, and a spacing between the two points may be defined as the entrance.

For example, the distance between a first point P1 and a second point P2 of FIG. 18 may correspond to the entrance size range (e.g., 80 cm to 110 cm), and the traveling direction at the first point P1 is opposite to the traveling direction at the second point P2, such that the spacing between the first point P1 and the second point P2 may be defined as the entrance.

In addition, the cleaning space may be classified into the plurality of cleaning regions (R1, R2, R3, R4) on the basis of the decided entrance.

For example, if the spacing between the first point P1 and the second point P2 of FIG. 18 is defined as the entrance, the cleaning space may be classified into the first cleaning region R1 and the second cleaning region R2 on the basis of the entrance.

In addition, each of the cleaning regions (R1, R2, R3, R4) may be classified into a plurality of cleaning blocks (CBs).

The respective cleaning blocks (CBs) may be identical in size to each other, and may be formed in a grid shape as shown in FIG. 19.

Each cleaning block (CB) may include unique position information, and may include information regarding the obstacle (wall, furniture, etc.) located in the cleaning space. The robot cleaner 100 may detect the obstacle through the obstacle detector 140 during traveling, and may also estimate the position of the obstacle through the cleaning block (CB) of the grid map (GM).

In addition, each cleaning block (CB) may include information regarding the cleaning region and the uncleaned region. The robot cleaner 100 may discriminate between the cleaned region and the uncleaned region through the cleaning block (CB) during traveling.

As described above, the grid map (GM) is generated by the traveling simulation of the 3D robot model (RM) on the 3D spatial model (MM), such that the grid map (GM) in which the traveling environment of the robot cleaner 100 is reflected can be generated.

Thereafter, the generated grid map (GM) may be stored in operation 1230.

As described above, the external appearance of the grid map (GM) may be formed by the traveling simulation of the 3D robot model (RM) on the 3D spatial model (MM). In addition, the cleaning space shown in the grid map (GM) may be classified into the plurality of cleaning regions, and each cleaning region may be classified into the plurality of cleaning blocks (CBs). As a result, the grid map (GM) including not only the cleaning space structure but also the obstacle contained in the cleaning space can be obtained.

The robot cleaner 100 or the manufacturer of the robot cleaner 100 may store the GM in the storage 180 of the robot cleaner 100. For example, the robot cleaner 100 or the manufacturer of the robot cleaner 100 may store map data in the storage 180 of the robot cleaner 100.

As described above, the GM may be stored in the robot cleaner 100 before the robot cleaner 100 initially travels in the user's cleaning space, and the grid map (GM) may indicate the cleaning space structure and the obstacle contained in the cleaning space.

Although the above-mentioned embodiment has exemplarily disclosed the method for generating the grid map (GM) using 3D modeling for convenience of description, the grid map (GM) generation method is not limited to application of the 3D modeling. For example, the image indicating the cleaning space may be directly extracted from the floor plan (FP), and the extracted image is classified into the plurality of cleaning regions, such that the grid map (GM) may also be acquired.

The above-mentioned embodiment has disclosed the method for generating the topological map (TM), the method for generating the grid map (GM), and the method for generating the topological-grid map (TGM).

Although the topological-grid map (TGM) is generated using the floor plan (FP), the user's cleaning space may be insufficiently reflected in the topological-grid map (TGM). For example, a step difference (i.e., a difference in step height) between the living room and the front entrance shown in the floor plan (FP) or a step difference between the living room and the bathroom shown in the floor plan (FP) may not be reflected in the topological-grid map (TGM).

Therefore, the stored topological-grid map (TGM) may be modified by the user prior to initial traveling of the robot cleaner 100, or may be modified during actual traveling of the robot cleaner 100.

A method for modifying the topological-grid map (TGM) by the user will hereinafter be given.

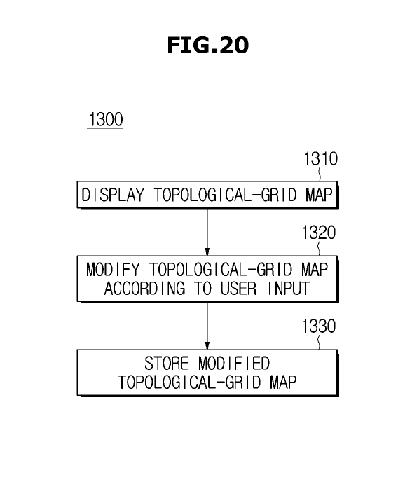

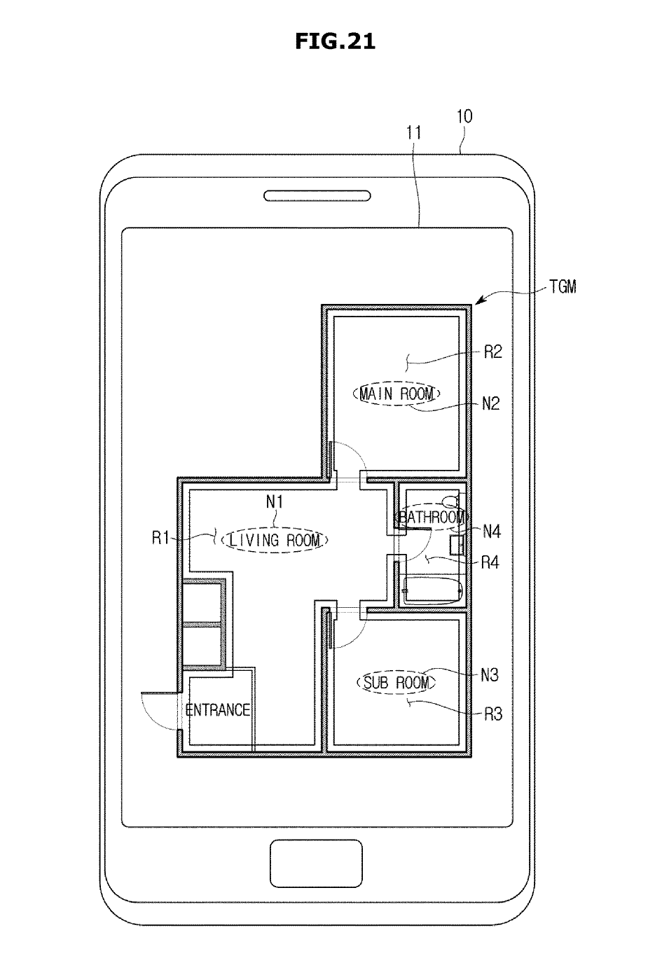

FIG. 20 is a flowchart illustrating a method for modifying a map according to one embodiment of the present disclosure. FIGS. 21 to 30 illustrate examples for modifying the topological-grid map according to the map modification method of FIG. 20.

The map modification method 1300 will hereinafter be described with reference to FIGS. 20 to 29.

The following map modification method 1300 may be carried out by the robot cleaner 100 or the user equipment (UE).

First, a topological-grid map (TGM) is displayed in operation 1310.

The topological-grid map (TGM) may be directly displayed on the robot cleaner 100 or may be displayed on the user equipment (UE).

For example, the robot cleaner 100 may directly display the topological-grid map (TGM) on the display 123, or may transmit the topological-grid map (TGM) to the user equipment (UE) designated by the user through the communicator 190. The user equipment (UE) 10 having received the topological-grid map (TGM) may display the topological-grid map (TGM) on a touchscreen 11 according to a user input.

The topological-grid map (TGM) may overlap the floor plan (FP) as shown in FIG. 21, such that the user can easily recognize the map. Whereas the topological-grid map (TGM) is a map for allowing the robot cleaner 100 to travel in the cleaning space, the floor plan (FP) is a map for displaying the cleaning space structure for user recognition, and the floor plan (FP) is more familiar to the user than the topological-grid map (GTM).

Accordingly, the topological-grid map (TGM) may overlap the floor plan (FP) such that the overlapping result is displayed.

The plurality of cleaning nodes (N1, N2, N3, N4) of the topological-grid map (TGM) may be respectively displayed on the cleaning regions (R1, R2, R3, R4) in a manner that the user can easily recognize the plurality of cleaning nodes (N1, N2, N3, N4).

In more detail, the first cleaning node N1 indicating the living room may be displayed in the first cleaning region R1, and the second cleaning node N2 indicating the main room may be displayed in the second cleaning region R2. In addition, the third cleaning node N3 indicating the sub room may be displayed in the third cleaning region R3, and the fourth cleaning node N4 indicating the bathroom may be displayed in the fourth cleaning region R4.

Thereafter, the topological-grid map (TGM) may be modified according to an input signal of the user (U) in operation 1320.

The topological-grid map (TGM) may be modified in various ways according to an input signal of the user (U).

For example, names of at least some parts of the plurality of cleaning nodes (N1, N2, N3, N4) may be modified by the user (U).

The cleaning nodes (N1, N2, N3, N4) contained in the topological-grid map (TGM) may be generated on the basis of the floor plan (FP). Therefore, names (e.g., living room, main room, sub room, and bathroom) of the cleaning nodes (N1, N2, N3, N4) may be different from actual names (e.g., living room, main room, kid's room, bathroom) y called by the actual user U. As a result, the user(U)-designated cleaning regions (e.g., living room, main room, kid's room, bathroom) may be different from the cleaning regions (e.g., living room, main room, kid's room, bathroom) recognized by the robot cleaner 100.

In conclusion, the robot cleaner 100 may not recognize a user command or may perform an operation irrelevant to user intention.

In order to prevent occurrence of the above operations, names of the cleaning nodes (N1, N2, N3, N4) may be modified according to user interest.

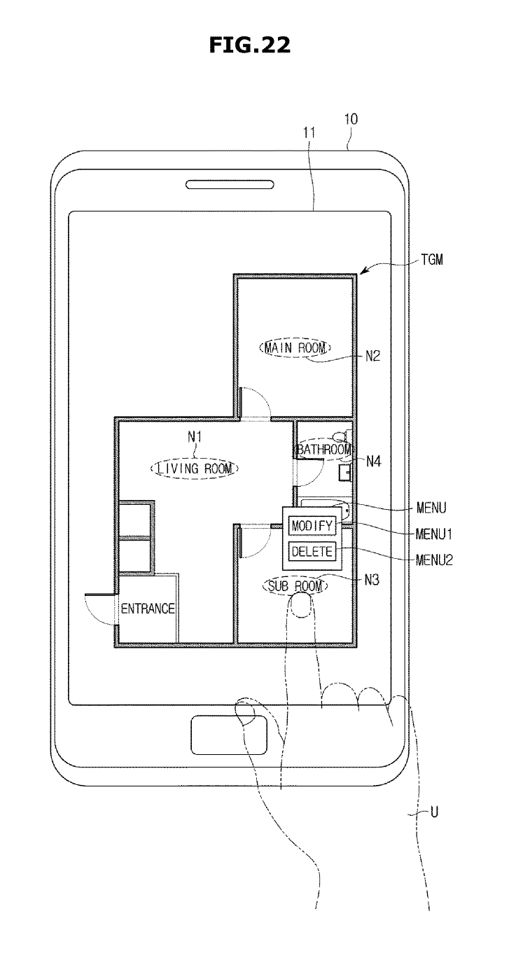

Referring to FIG. 22, if the user selects the third cleaning node N3 from among the plurality of cleaning nodes (N1, N2, N3, N4), the popup menu (MENU) for modifying the third cleaning node N3 may be displayed. In this case, the user may select the third cleaning node N3 in various ways. For example, the user may touch the part on which the third cleaning node N3 is displayed, for a long period of time, or may successively touch the part two times.

The popup menu (MENU) may include a modified menu (MENU1) for modifying attributes of the third cleaning node N3 and a deletion menu (MENU2) for deleting the third cleaning node N3.

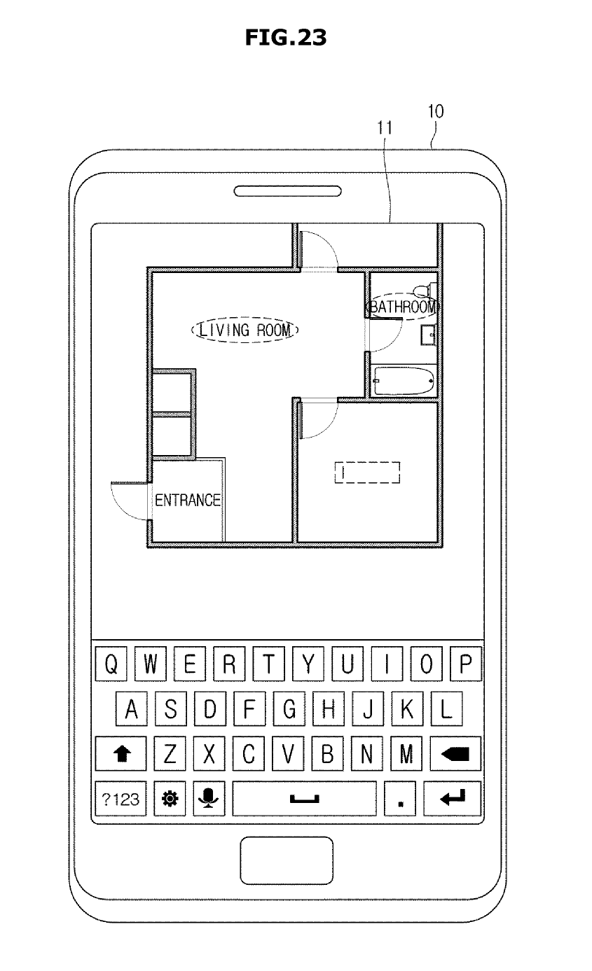

If the user selects the modification menu (MENU1) in the popup menu (MENU), a keypad (KEY) for allowing the user to input letters, numbers, or symbols may be displayed on the touchscreen 11 as shown in FIG. 23.

The user (U) touches letters, numbers, or symbols displayed on the keypad (KEY) so as to input a new name of the third cleaning node N3.

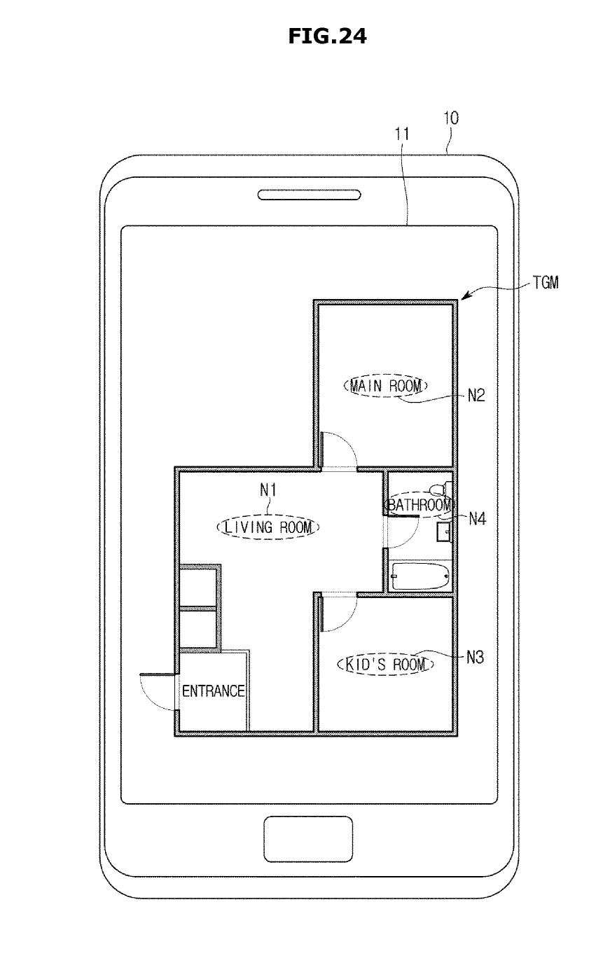

If the user (U) inputs a new name of the third cleaning node N3, the new name of the third cleaning node N3 may be displayed on the topological-grid map (TGM) as shown in FIG. 24.

In another example, at least some parts of the cleaning nodes (N1, N2, N3, N4) may be deleted by the user (U).

The cleaning nodes (N1, N2, N3, N4) and the cleaning regions (R1, R2, R3, R4) contained in the topological-grid map (TGM) may be generated on the basis of the floor plan (FP). Therefore, the actual cleaning space structure, information indicating whether or not the robot cleaner 100 can enter, and user intention may not be reflected to the topological-grid map (TGM).

Specifically, according to the topological-grid map (TGM), the cleaning region where the robot cleaner 100 cannot enter due to a step difference not reflected to the floor plan (FP), or the other cleaning region undesired by the user may be stored as a cleaning region to be cleaned by the robot cleaner 100.

As a result, the robot cleaner 100 may malfunction or may perform an operation opposed to user intention.

In order to address the above-mentioned issue, the plurality of cleaning nodes (N1, N2, N3, N4) indicating the plurality of cleaning regions (R1, R2, R3, R4) may be deleted according to user interest.

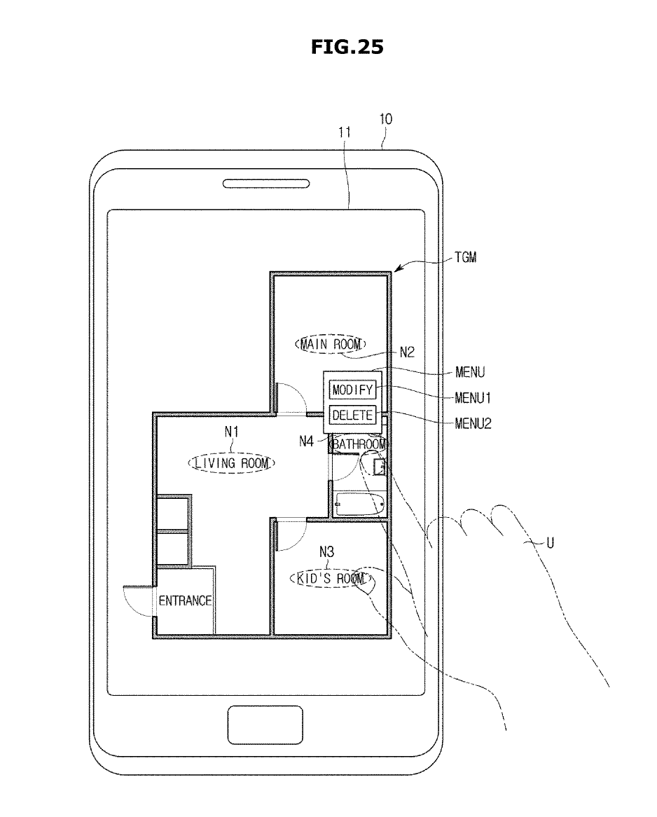

In more detail, if the fourth cleaning node N4 from among the cleaning nodes (N1, N2, N3, N4) is selected by the user as shown in FIG. 25, the popup menu (MENU) for modifying the fourth cleaning node N4 may be displayed.

As described above, the popup menu (MENU) may display a modify menu (MENU1) for modifying attributes of the fourth cleaning node N4 and a delete menu (MENU2) for deleting the fourth cleaning node N4.

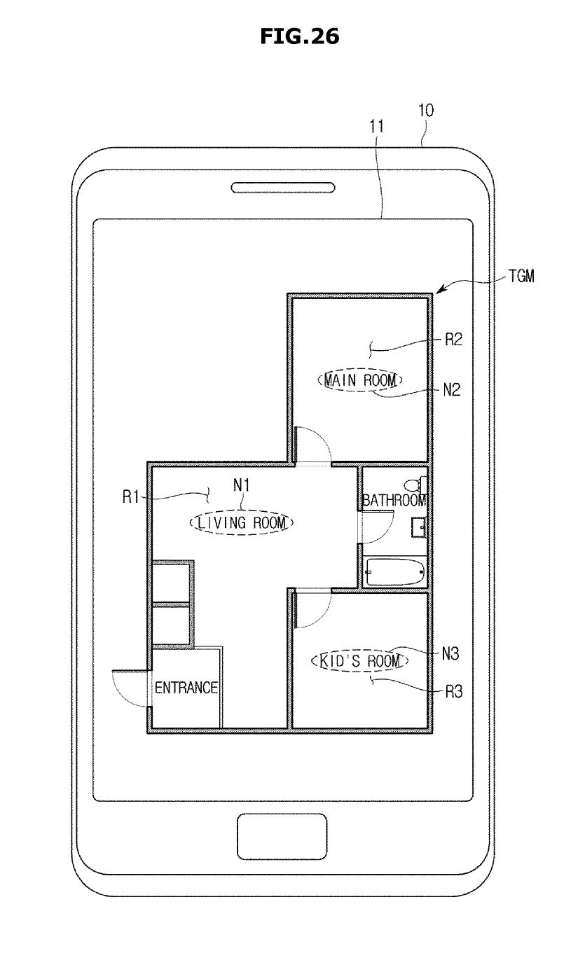

If the user (U) selects the delete menu (MENU2) in the popup menu (MENU), the topological-grid map (TGM) from which the fourth cleaning node N4 is deleted may be displayed as shown in FIG. 26. In this case, the fourth cleaning node N4 is deleted, and at the same time the fourth cleaning region R4 can be deleted from the topological-grid map (TGM).

In another example, the obstacle may be added to the cleaning regions (R1, R2, R3) by the user (U).

The cleaning nodes (N1, N2, N3) and the cleaning regions (R1, R2, R3) contained in the topological-grid map (TGM) may be generated on the basis of the floor plan (FP). Accordingly, the obstacle newly arranged in the cleaning space by the user U and the no-entry region caused by user (U)'s intention may not be reflected in the topological-grid map (TGM).

As a result, the robot cleaner 100 may wrongly recognize position thereof due to an unexpected obstacle (O) encountered while the robot cleaner 100 travels in the cleaning space 100.

In order to address this issue, a new obstacle (O) may be added to the topological-grid map (TGM) by the user (U).

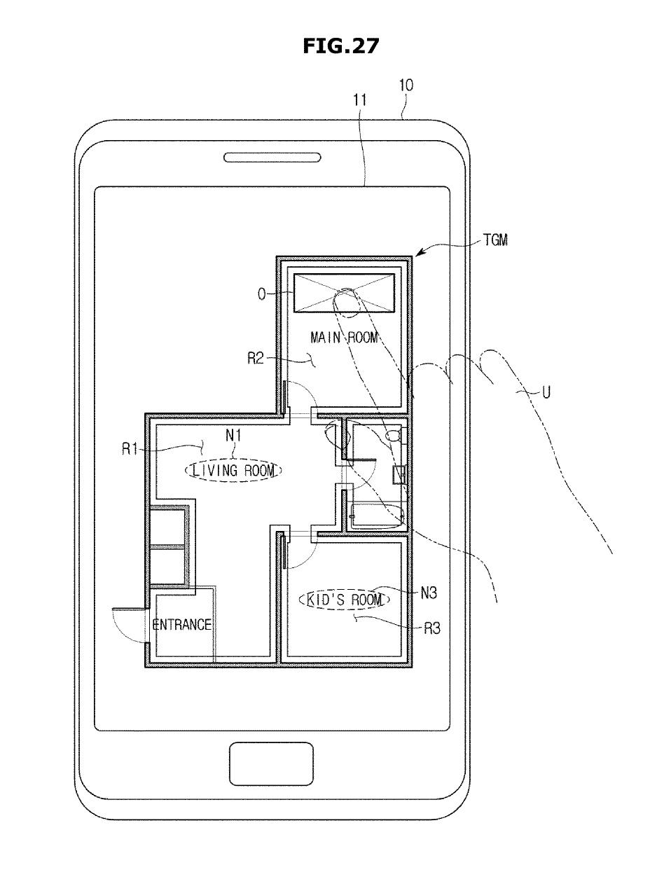

In more detail, as shown in FIG. 27, the user (U) may move the obstacle (O) to the cleaning regions (R1, R2, R3) shown in the topological-grid map (TGM). Alternatively, the user (U) may generate the closed region in the cleaning regions (R1, R2, R3), and may determine the generated closed region to be the no-entry region.

As described above, if the user (U) adds the new obstacle (O) to the topological-grid map (TGM), the cleaning regions (R1, R2, R3) or the cleaning nodes (N1, N2, N3) of the topological-grid map (TGM) may be modified by the new obstacle (O).

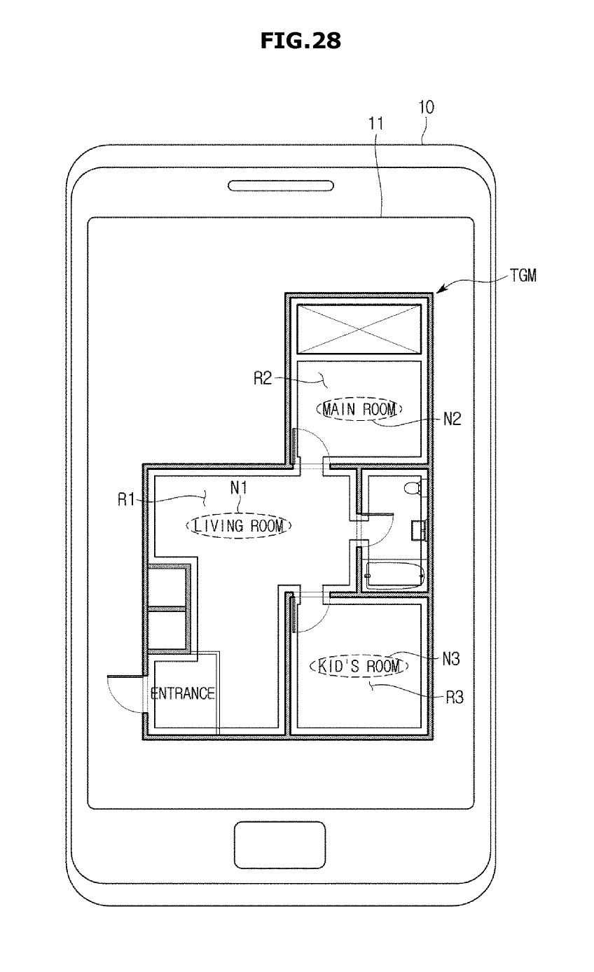

In more detail, if the obstacle (O) or the no-entry region is added to the second cleaning region R2 as shown in FIG. 28, the second cleaning region R2 of the topological-grid map (TGM) may be modified according to the added obstacle (O) or the no-entry region.

In another example, an access point (AP) for communication of the robot cleaner 100 may be added to the cleaning space by the user (U).

The cleaning nodes (N1, N2, N3) and the cleaning regions (R1, R2, R3) contained in the topological-grid map (TGM) are generated on the basis of the floor plan (FP), such that the position of the AP arranged in the cleaning space may not be reflected to the topological-grid map (TGM).

The AP (Access Point) position may be used as an important means for recognizing the position of the robot cleaner 100. Accordingly, the topological-grid map (TGM) may include the AP position.

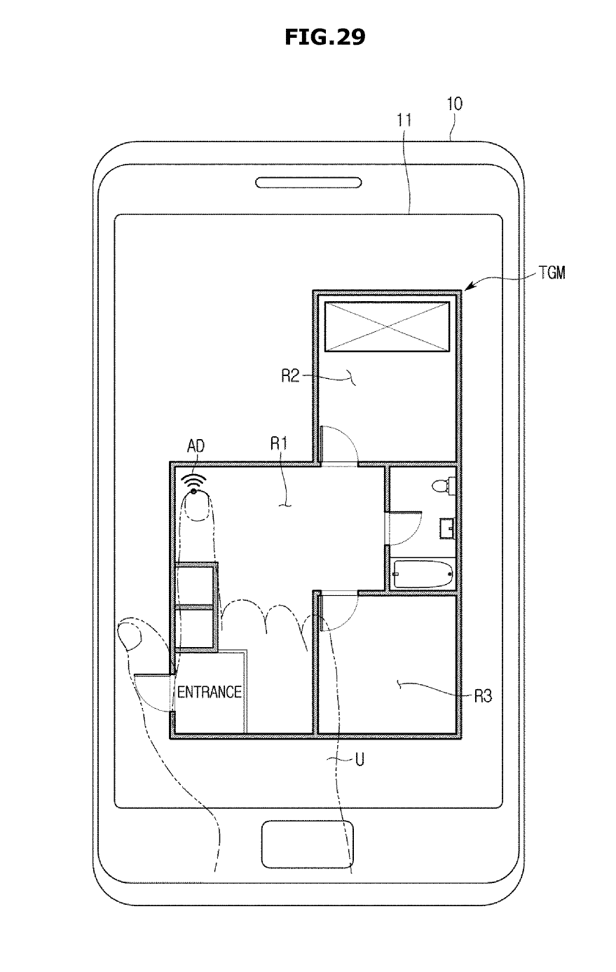

In more detail, as shown in FIG. 29, the user (U) may input a position setting command of the AP, and the user may touch the AP arrangement position in the topological-grid map (TGM).

As described above, if the user (U) adds the AP position to the topological-grid map (TGM), the AP position is added to the topological-grid map (TGM), intensity of a radio frequency (RF) signal of the cleaning space may be modeled on the basis of the AP position. As a result, RF signal intensity map data indicating intensity of the RF signal generated from the AP may be generated.

In another example, the positions of lamps (LP1, LP2, LP3) arranged in the cleaning space may be added by the user (U).

Since the cleaning nodes (N1, N2, N3) and the cleaning regions (R1, R2, R3) contained in the topological-grid map (TGM) are generated on the basis of the floor plan (FP), the positions of the lamps (LP1, LP2, LP3) arranged in the cleaning space may not be reflected in the topological-grid map (TGM).

The positions of the lamps (LP1, LP2, LP3) may be used as an important means for recognizing the position of the robot cleaner 100. Accordingly, the topological-grid map (TGM) may include the positions of the lamps (LP1, LP2, LP3).

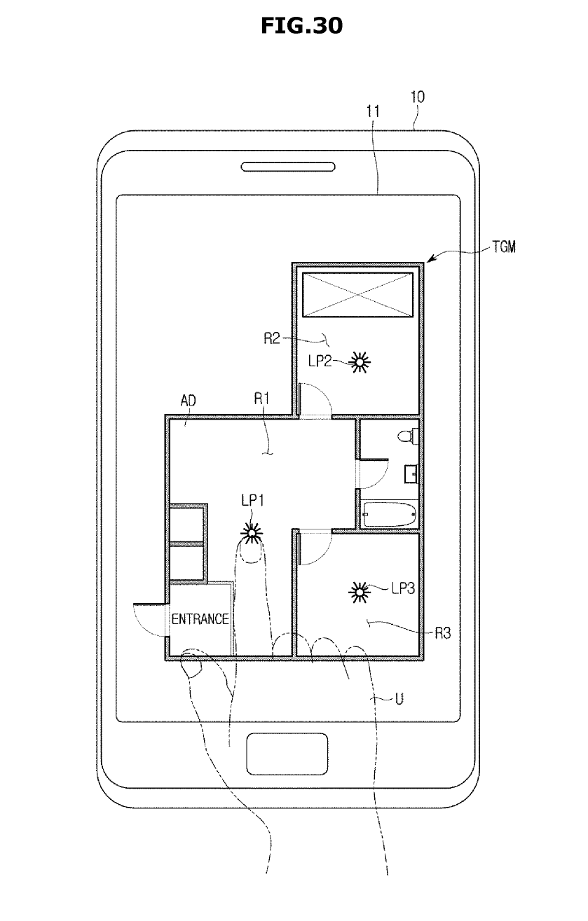

In more detail, as shown in FIG. 30, the user (U) may input a position setting command of the lamps (LP1, LP2, LP3), and the user may touch the arrangement positions of the lamps (LP1, LP2, LP3) in the topological-grid map (TGM).

As described above, if the user (U) adds the positions of the lamps (LP1, LP2, LP3) to the topological-grid map (TGM), the positions of the lamps (LP1, LP2, LP3) are added to the topological-grid map (TGM), and illumination of the cleaning space is modeled on the basis of the positions of the lamps (LP1, LP2, LP3). As a result, illumination map data indicating output illumination of the lamps (LP1, LP2, LP3) may be generated.

In order to allow the robot cleaner 100 to travel in the cleaning space, the operation for allowing the robot cleaner 100 to determine the position thereof is of importance to the robot cleaner 100.

The robot cleaner 100 may determine the position thereof in various ways. For example, the robot cleaner 100 may determine the position thereof on the basis of geomagnetic information, GPS signals, lamp illumination, RF signal of the access point (AP), etc.

Specifically, the robot cleaner 100 designed to travel in the indoor space may use intensity of the RF signal generated from the AP and illumination of the lamps (LP1, LP2, LP3) as the most important factors during the process of determining the position of the robot cleaner 100.

In order to allow the robot cleaner 100 to determine the position thereof within the cleaning space, the topological-grid map (TGM) may include RF signal intensity information or illumination information at each position contained in the cleaning space. The robot cleaner 100 may compare the RF signal intensity of the topological-grid map (TGM) with the actually received RF signal intensity, or may compare an illumination level of the topological-grid map (TGM) with the actually measured illumination level, such that the robot cleaner 100 may determine the position thereof.

As described above, in order to add RF signal intensity or illumination information in relation to position to the topological-grid map (TGM), the RF signal intensity or illumination information of the cleaning space may be modeled on the basis of the AP position.

In addition, RF signal intensity map data including the RF signal intensity or illumination expected at each position may be generated on the basis of the modeling result of RF signal intensity or illumination. In addition, the RF signal map data or the illumination information may be added to the respective cleaning blocks (CBs) contained in the topological-grid map (TGM).

As described above, information regarding the RF signal intensity or illumination needed to determine the position of the robot cleaner 100 may be contained in the topological-grid map (TGM). However, information for determining the position of the robot cleaner 100 is not limited to the RF signal intensity or illumination.

For example, the topological-grid map (TGM) may include geomagnetic map data caused by the earth's magnetic field so as to determine the position of the robot cleaner 100. The geomagnetic map data may be generated on the basis of the position of the cleaning space (latitude and longitude) and the cleaning space structure.

The robot cleaner 100 may determine the position thereof on the basis of the RF signal intensity, illumination, and geomagnetic field intensity.

Thereafter, the modified topological-grid map (TGM) may be stored in the robot cleaner 100 in operation 1330.

As described above, the topological-grid map (TGM) modified by the user may be carried out by the robot cleaner 100 or by the user equipment (UE).

If modification of the topological-grid map (TGM) is carried out in the robot cleaner 100, the controller 110 of the robot cleaner 100 may store the modified topological-grid map (TGM) in the storage 180.

In addition, if modification of the topological-grid map (TGM) is carried out in the UE 10, the robot cleaner 100 may receive the modified topological-grid map (TGM) through the communicator 190, and the controller 110 of the robot cleaner 100 may store the modified topological-grid map (TGM) in the storage 180.

As described above, the pre-manufactured topological-grid map (TGM) may be modified by the user.

A method for modifying the topological-grid map (TGM) during traveling of the robot cleaner 100 will hereinafter be described.

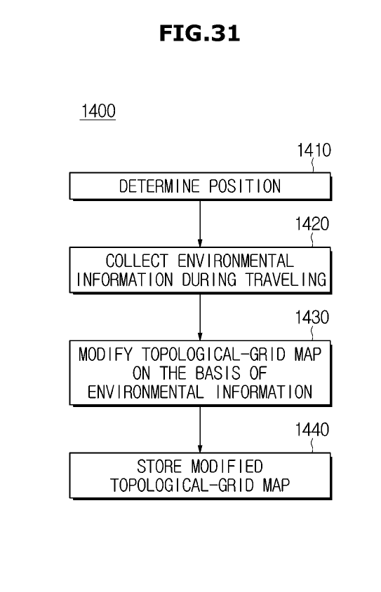

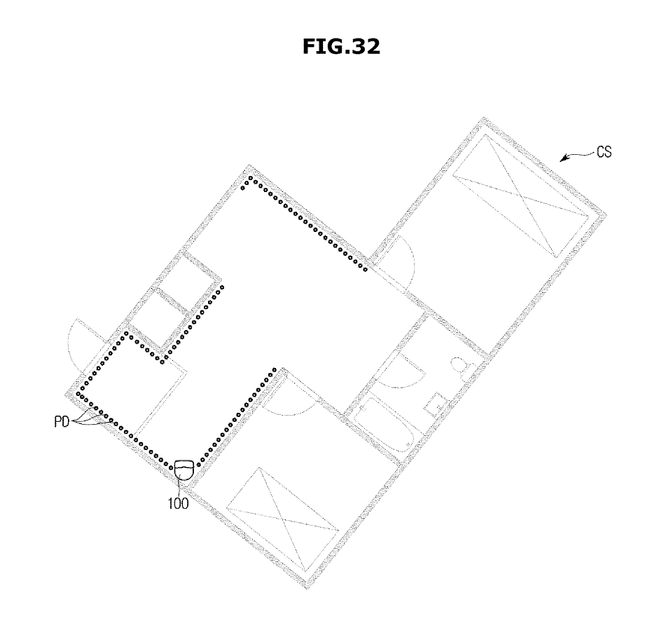

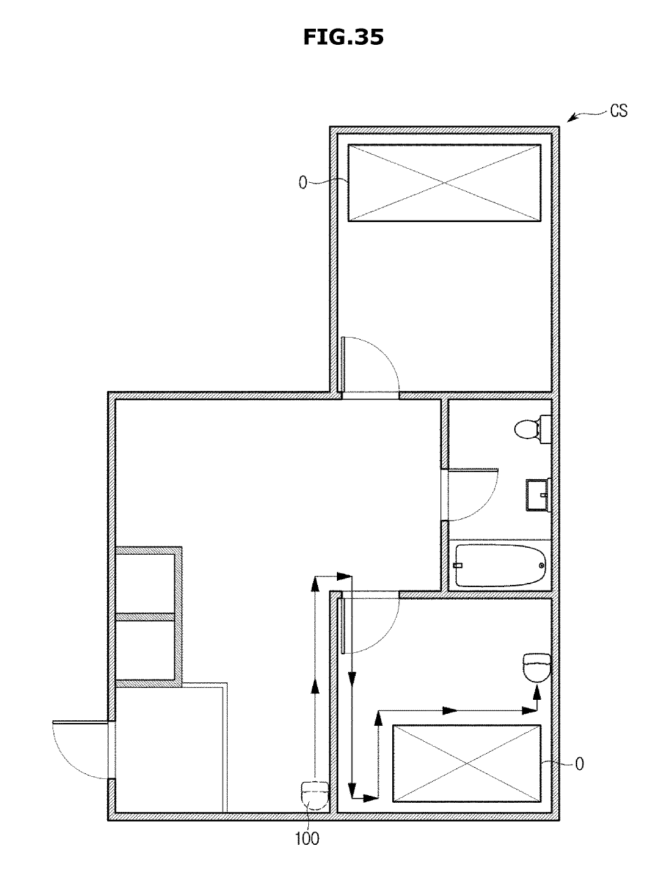

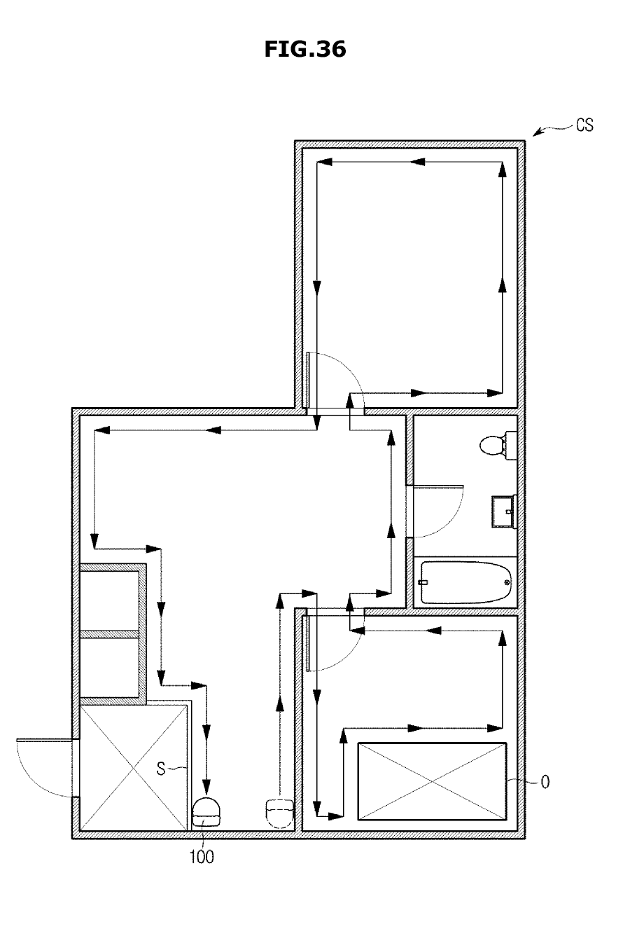

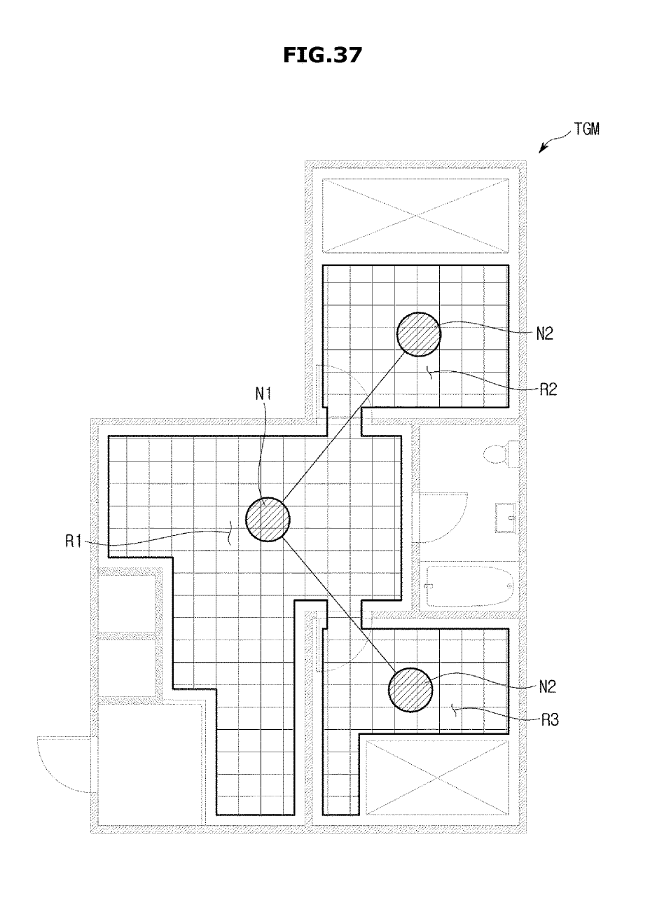

FIG. 31 is a flowchart illustrating a method for modifying a map according to another embodiment of the present disclosure. FIGS. 32 to 34 are conceptual diagrams illustrating a method for determining the position of a robot cleaner according to the map modification method of FIG. 31. FIGS. 35 and 36 are conceptual diagrams illustrating methods for allowing the robot cleaner traveling in the cleaning space to collect environmental information according to the map modification method of FIG. 31. FIG. 37 is a view illustrating the topological-grid map modified by the map modification method of FIG. 31.

The map modification method 1400 will hereinafter be described with reference to FIGS. 31 to 37.

First, the robot cleaner 100 may determine the position thereof in operation 1410.

The robot cleaner 100 may collect environmental information of the actual cleaning space (CS), and may determine the position thereof on the basis of the collected environmental information.

For example, the robot cleaner 100 may determine the position thereof on the basis of the position information of the obstacle detected by the obstacle detector 140.

As described above, the obstacle detector 140 may detect the obstacle located in the traveling direction of the robot cleaner 100, and the controller 110 may calculate the size and position of the obstacle on the basis of the detection result of the obstacle detector 140.

If the robot cleaner 100 is arranged in the actual cleaning space (CS), the robot cleaner 100 may rotate in place and may detect the obstacle located in the forward direction of the robot cleaner 100.

The controller 110 of the robot cleaner 100 may acquire detection data (DD) indicating the structure of the actual cleaning space (CS) on the basis of the detection result of the obstacle detector 140. Here, the detection data (DD) may be changed according to the sensing distance of the obstacle detector 140. For example, as shown in FIG. 32, the robot cleaner 100 arranged in the cleaning space may calculate the distance from the robot cleaner 100 to the obstacle (e.g., the wall located in the cleaning space) using the obstacle detector 140, and may acquire detection data (DD) indicating the structure of the actual cleaning space (CS) on the basis of the calculated distance.

Thereafter, the robot cleaner 100 may compare detection data (DD) of the actual cleaning space (CS) acquired through the obstacle detector 140 with the topological-grid map (TGM) stored in the storage 180, such that the robot cleaner 100 can recognize the position thereof.

In more detail, the controller 110 of the robot cleaner 100 may perform rotational movement or parallel movement of detection data (DD) of the actual cleaning space (CS) obtained through the obstacle detector 140, such that the controller 110 may search for a specific position at which the detection data (DD) of the actual cleaning space (CS) is identical to the topological-grid map (TGM). If the specific position is detected, the controller 110 may determine this specific position to be its own current position.

In another example, the robot cleaner 100 may determine the position thereof on the basis of intensity of the RF signal received from the access point (AP).

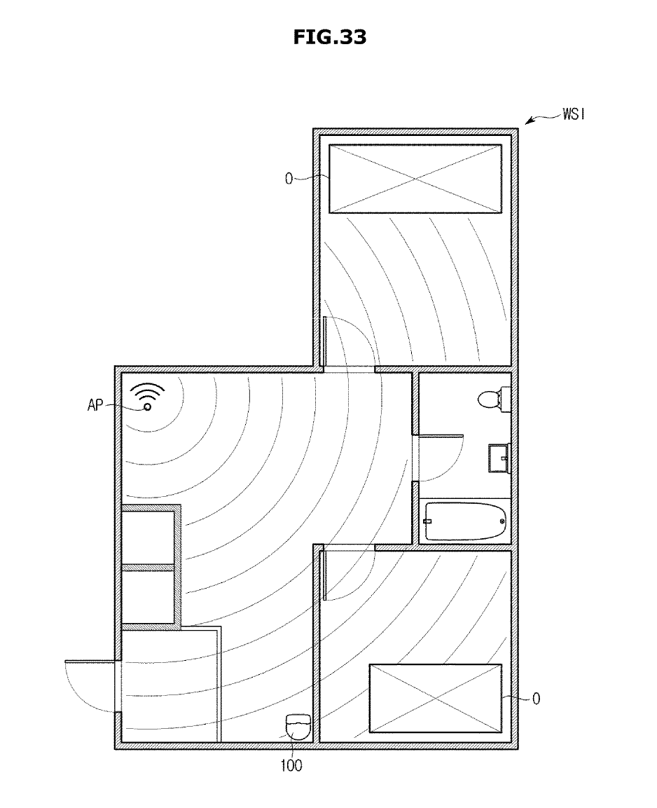

As described above, the topological-grid map (TGM) may include RF signal intensity map data (WSI) indicating intensity of the RF signal received from each cleaning block. The RF signal intensity map data (WSI) may include information regarding the RF signal intensity based on each position contained in the cleaning space as shown in FIG. 33.

The robot cleaner 100 may compare the intensity of the RF signal received from the AP through the communicator 190 with the RF signal intensity map data (WSI), and may determine the position thereof according to the result of comparison.

In another example, the robot cleaner 100 may determine the position thereof on the basis of illumination information.

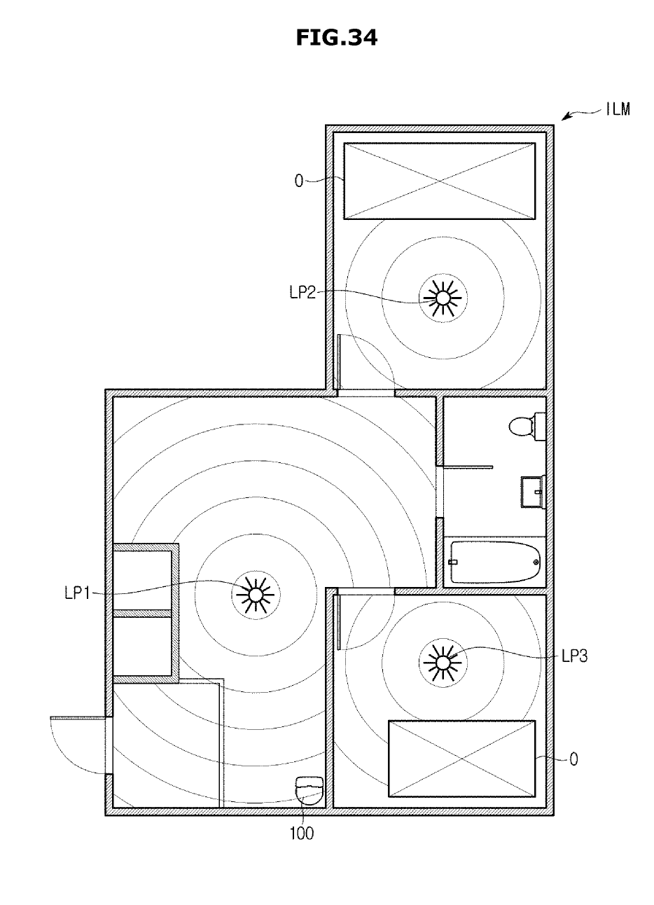

As described above, the topological-grid map (TGM) may include illumination map data (ILM) indicating illumination of each cleaning block (CB). The illumination map data (ILM) may include illumination information based on each position of the cleaning space as shown in FIG. 34.

The robot cleaner 100 may compare the actually measured illumination value with the illumination map data (ILM), and may determine the position of the robot cleaner 100 according to the result of comparison.

In another example, the robot cleaner 100 may determine the position thereof on the basis of geomagnetic information. The robot cleaner 100 may compare the actually measured geomagnetic strength with geomagnetic information contained in the topological-grid map (TGM), and may determine the position of the robot cleaner 100 according to the result of comparison.

In another example, the robot cleaner 100 may determine the position thereof on the basis of the image acquired by the image acquirer 150.

The robot cleaner 100 may acquire the ceiling image of the cleaning space using the upward camera module 151 contained in the image acquirer 150.

In this case, the controller 110 of the robot cleaner 100 may predict the peripheral structure of the robot cleaner 100 on the basis of the ceiling image. In addition, the robot cleaner 100 may determine the position thereof by comparing the predicted peripheral structure with the topological-grid map (TGM).

Specifically, the controller 110 of the robot cleaner 100 may perform rotational movement or parallel movement of the predicted peripheral structure, such that the controller 110 may search for a specific position at which map data of the cleaning space is identical to the topological-grid map (TGM). If the specific position is detected, the controller 110 may determine this specific position to be the position thereof.

As described above, the robot cleaner 100 may determine the position thereof in various ways. In addition, the robot cleaner 100 may determine the position thereof using at least one or at least two of the above-mentioned position decision methods.

Thereafter, the robot cleaner 100 may collect environmental information of the actual cleaning space (CS) while traveling in the cleaning space (CS) on the basis of the topological-grid map (TGM) in operation 1420.

In addition, the robot cleaner 100 may modify the topological-grid map (TGM) on the basis of the collected environmental information of the actual cleaning space (CS) in operation 1430.

If the position of the robot cleaner 100 is determined, the controller 110 of the robot cleaner 100 may generate the traveling path on the basis of the topological-grid map (TGM), and may travel along the generated path.

In this case, the robot cleaner 100 may collect the environmental information of the actual cleaning space (CS) using the movement detector 130, the obstacle detector 140, and the image acquirer 150 while traveling about the cleaning space, and may modify the topological-grid map (TGM) on the basis of the collected environment information.

Since the topological-grid map (TGM) is generated on the basis of the floor plan (FP), the obstacle (O) not reflected in the floor plan (FP) may be arranged in the cleaning space. The robot cleaner 100 may detect the obstacle (O) during traveling, and may modify the topological-grid map (TGM) on the basis of the detected obstacle position.

For example, the robot cleaner 100 may perform wall tracing traveling according to a user command.

During the wall tracing traveling, the robot cleaner 100 may discover the obstacle (O) not written in the topological-grid map (TGM) through the obstacle detector 140. As described above, if the obstacle (O) not written in the topological-grid map (TGM) is discovered, the robot cleaner 100 may travel along the outline of the obstacle (O) as shown in FIG. 35. In addition, while the robot cleaner travels along the outline of the obstacle (O), the robot cleaner 100 may store the traveling record in the storage 180 on the basis of the detection result of the movement detector 130.

In addition, the robot cleaner 100 may discover a step difference (S) not written in the topological-grid map (TGM) through the obstacle detector 140 or the like. As described above, if the obstacle (O) not written in the topological-grid map (TGM) is discovered, the robot cleaner 100 may travel along the outline of the step difference (S) as shown in FIG. 36. In addition, while the robot cleaner 100 travels along the outline of the step difference (S), the robot cleaner 100 may store the traveling record in the storage 180 on the basis of the detection result of the movement detector 130.

If such traveling is finished, the robot cleaner 100 may modify the topological-grid map (TGM) on the basis of the traveling record stored in the storage 180.

For example, the robot cleaner 100 may reflect information regarding the obstacle (O) or step difference (S) not written in the topological-grid map (TGM) to the topological-grid map (TGM), such that the topological-grid map (TGM) can be modified as shown in FIG. 37.

Thereafter, the modified topological-grid map (TGM) may be stored in the robot cleaner 100 in operation 1440.

The topological-grid map (TGM) modification caused by traveling may be carried out by the robot cleaner 100.

The controller 110 of the robot cleaner 100 may store the topological-grid map (TGM) modified during traveling of the robot cleaner 100 in the storage 180.

As described above, the pre-manufactured topological-grid map (TGM) may be modified on the basis of environmental information collected during traveling of the robot cleaner 100.

In addition, the robot cleaner 100 may display the cleaning progress state on the basis of the topological-grid map (TGM) while traveling in the cleaning space for user recognition, or may receive various control commands from the user on the basis of the topological-grid map (TGM).

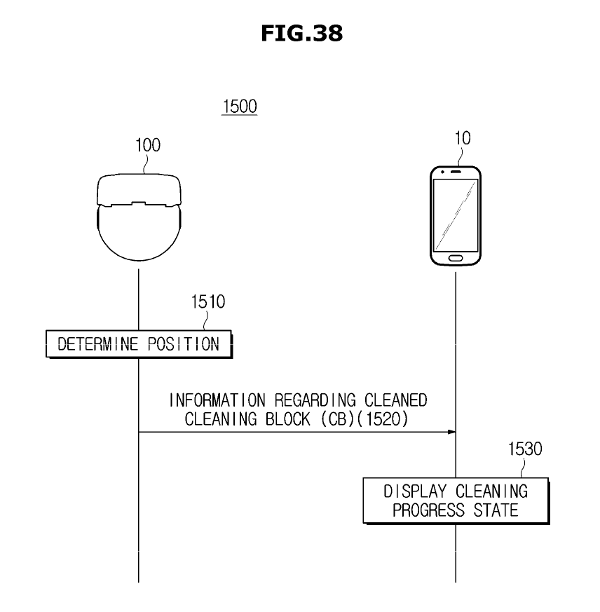

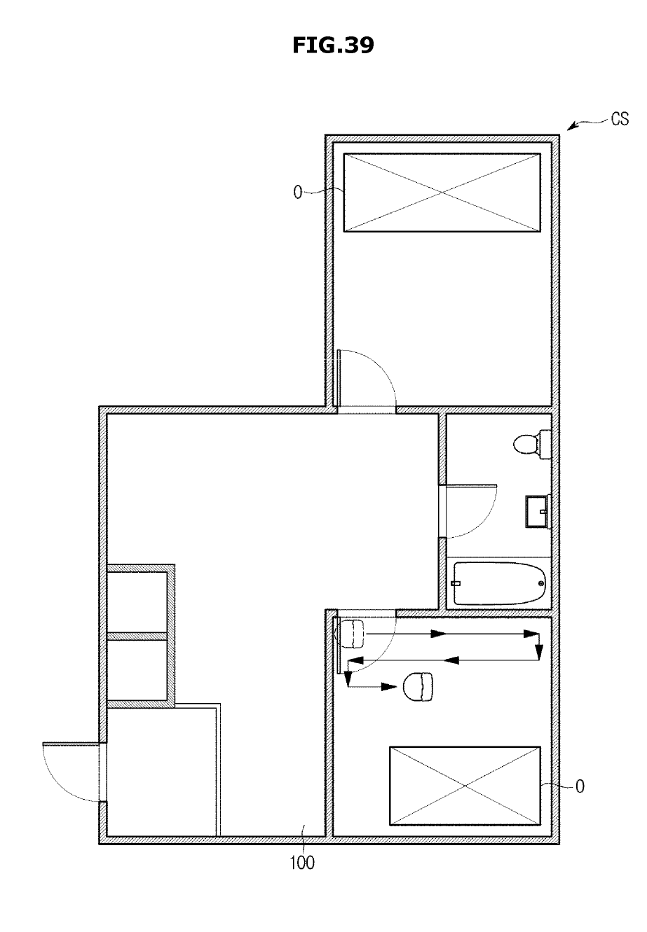

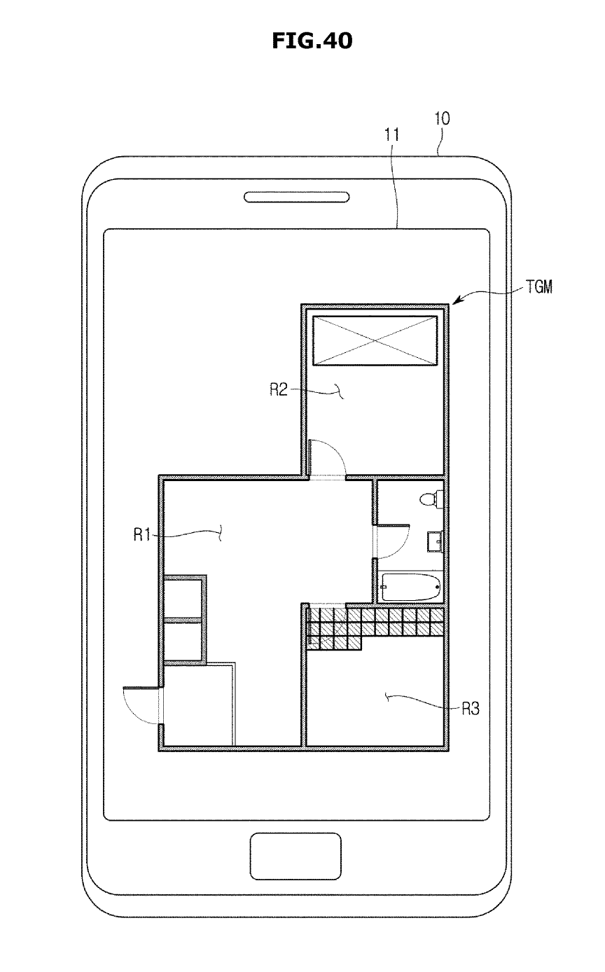

FIG. 38 is a conceptual diagram illustrating a method for displaying a cleaning progress state according to an embodiment of the present disclosure. FIGS. 39 and 40 are conceptual diagrams illustrating examples for displaying a cleaning progress state according to the method of FIG. 38.

A method 1500 for displaying the cleaning progress state will hereinafter be described with reference to FIGS. 38, 39 and 40.

First, the robot cleaner 100 may determine the position thereof during the cleaning process in operation 1510.

The robot cleaner 100 may collect environmental information of the actual cleaning space (CS), and may determine the position thereof on the basis of the collected environmental information.

For example, the robot cleaner 100 may determine the position thereof on the basis of the position of the obstacle, may determine the position thereof on the basis of the RF signal intensity, may determine the position thereof on the basis of illumination, or may determine the position thereof on the basis of the ceiling image of the cleaning space. In addition, the robot cleaner 100 may determine the position thereof on the basis of the traveling initiation position and the detection result of the movement detector 130.

The robot cleaner 100 may transmit information regarding the cleaned cleaning block to the user equipment (UE) in operation 1520.

In more detail, the robot cleaner 100 may determine the cleaning block (CB) on the basis of the position thereof and the topological-grid map (TGM). In addition, the robot cleaner 100 may determine whether or not the cleaner 170 is driven, and may determine which one of the cleaning blocks (CBs) was cleaned on the basis of the cleaning block (CB) at which the robot cleaner 100 is located.

In this case, the robot cleaner 100 may separately store the cleaned cleaning block (CB), and may reflect the cleaned cleaning block (CB) in CB data contained in the topological-grid map (TGM).

In addition, the robot cleaner 100 may transmit information regarding the cleaned cleaning block (CB) to the user equipment (UE).

The user equipment (UE) 10 may display the cleaning progress state on the basis of the received cleaning block (CB) associated information in operation 1530.

In more detail, the user equipment (UE) 10 may determine which one of cleaning blocks (CBs) was cleaned by the robot cleaner 100 on the basis of the separately stored topological-grid map (TGM) and the received cleaning block (CB) associated information.

Thereafter, the user equipment (UE) 10 may visually display the cleaning block (CB) cleaned by the robot cleaner 100 so as to display the cleaning progress state.

For example, the user equipment (UE) 10 may display the cleaning progress state on the topological-grid map (TGM) as shown in FIG. 40.

For example, the user equipment (UE) 10 may display the cleaned cleaning block (CB) and the uncleaned cleaning block (CB) to be distinguished from each other on the topological-grid map (TGM). In addition, the user equipment (UE) 10 may display only the cleaned cleaning block (CB) on the topological-grid map.

Through the cleaning block (CB) displayed on the topological-grid map (TGM), the user can easily recognize the cleaning progress state.

As described above, the cleaned cleaning block (CB) may be displayed on the topological-grid map (TGM) so as to display the cleaning progress state.

In addition, the robot cleaner 100 may receive a user command from the user equipment (UE) 10 when displaying the cleaning progress state on the user equipment (UE) 10.

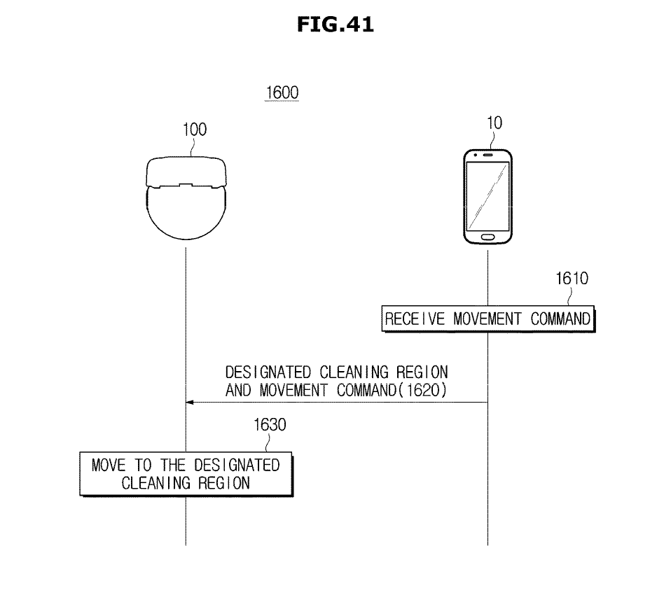

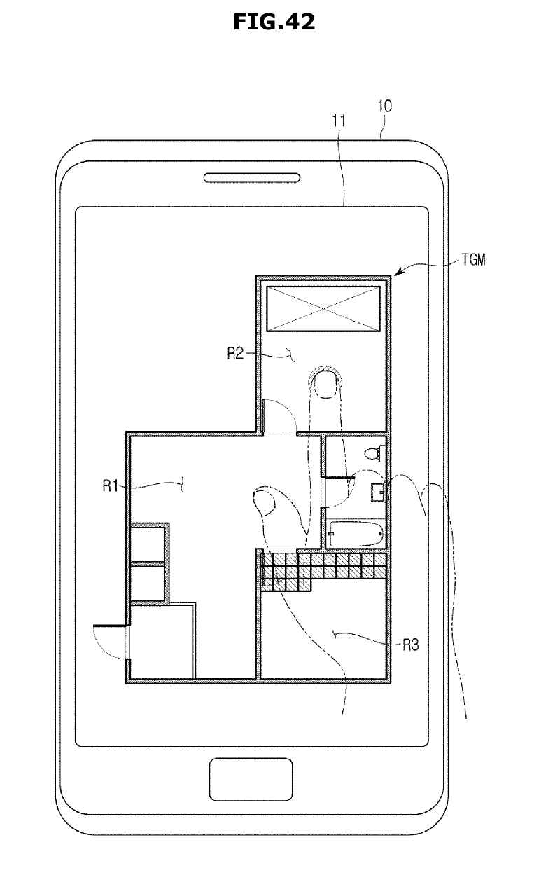

FIG. 41 is a conceptual diagram illustrating an exemplary interaction between the robot cleaner and a user terminal (also called a user equipment UE) according to an embodiment of the present disclosure. FIGS. 42, 43, and 44 illustrate examples of interaction between the robot cleaner and the user equipment (UE) according to the method of FIG. 41.

A method 1600 for controlling the robot cleaner 100 to interact with the user equipment (UE) 10 will hereinafter be described with reference to FIGS. 41 to 44.

The user equipment (UE) 10 may receive a movement command from the user when displaying the cleaning progress state in operation 1610.

As described above, the user equipment (UE) may display the cleaning progress state on the topological-grid map (TGM).

In this case, the user may input a movement command for commanding the robot cleaner 100 to enter the cleaning region to be cleaned.

For example, as shown in FIG. 42, if the robot cleaner 100 cleans the third cleaning region R3, the user may input a movement command for commanding the robot cleaner 100 to enter the second cleaning region R2 through the user equipment (UE).

In more detail, the user may touch the second cleaning region R2 contained in the topological-grid map (TGM) displayed on the user equipment (UE) 10, and may input a movement command for allowing the robot cleaner 100 to enter the second cleaning region R2 through the user equipment (UE) 10.

In addition, the user may verbally input the movement command for the second cleaning region R2 to the robot cleaner 100.

The user may combine the name “Main Room” of the second cleaning region R2 with the movement command “Move” so that the user can verbally input a voice command “Go to the main room”. The user equipment (UE) 10 having received the voice command may process the received voice command and thus recognize the movement command for the second cleaning region.

Thereafter, the user equipment (UE) 10 may transmit the stored cleaning region and the movement command to the robot cleaner 100 in operation 1620.

The robot cleaner 100 may receive the cleaning region designated by the user and the movement command through the communicator 190.

The cleaning robot 100 having received the movement command may enter the user-designated cleaning region in operation 1630.

In more detail, the robot cleaner 100 may stop cleaning upon receiving the movement command.

Thereafter, the robot cleaner 100 may determine the position of the user-designated cleaning region by referring to the topological-grid map (TGM), and may calculate the shortest path from the current position to the user-designated cleaning region.

In order to calculate the shortest path to the user-designated cleaning region, the robot cleaner 100 may use the connectivity relationship among the plurality of nodes contained in the topological map (TM).

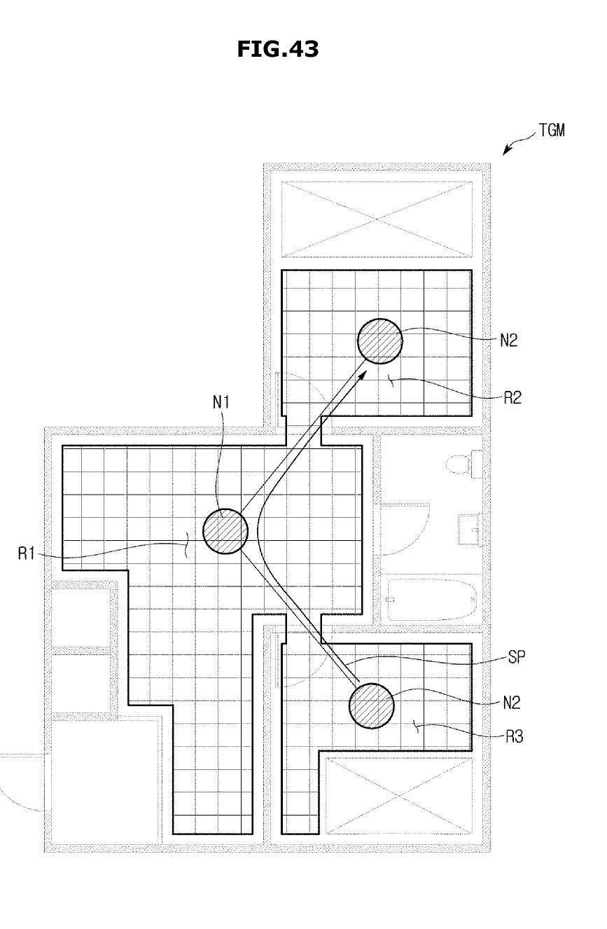

For example, as shown in FIG. 43, if the movement command for commanding the robot cleaner 100 to move from the third cleaning region R3 to the second cleaning region R2 is received, the robot cleaner 100 may calculate the shortest path (SP) on the basis of the connectivity relationship among the first cleaning node N1, the second cleaning node N2, and the third cleaning node N3. In more detail, the robot cleaner 100 may calculate the shortest path (SP) through which the robot cleaner moves from the third cleaning region R3 to the second cleaning region R2 after passing through the first cleaning region R1.

If the shortest path (SP) is calculated, the robot cleaner 100 may simplify the calculated shortest path (SP) using the grid map (GM). In more detail, the robot cleaner 100 may simplify the path from the third cleaning region R3 to the first cleaning region R1 using the grid map (GM), and may simplify the path from the first cleaning region R1 to the second cleaning region R2.

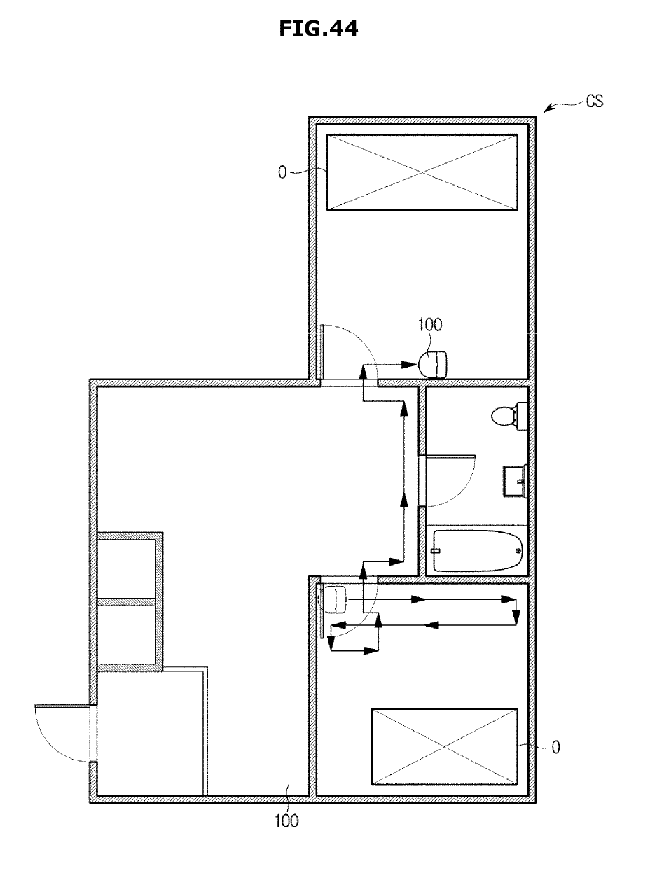

Thereafter, as shown in FIG. 44, the robot cleaner 100 may move to the user-designated cleaning region along the simplified cleaning path, and may restart cleaning after arriving at the user-designated cleaning region.

As described above, upon receiving the movement command toward a target cleaning region, the robot cleaner 100 may calculate the shortest path (SP) to the target cleaning region using the topological-grid map (TGM).

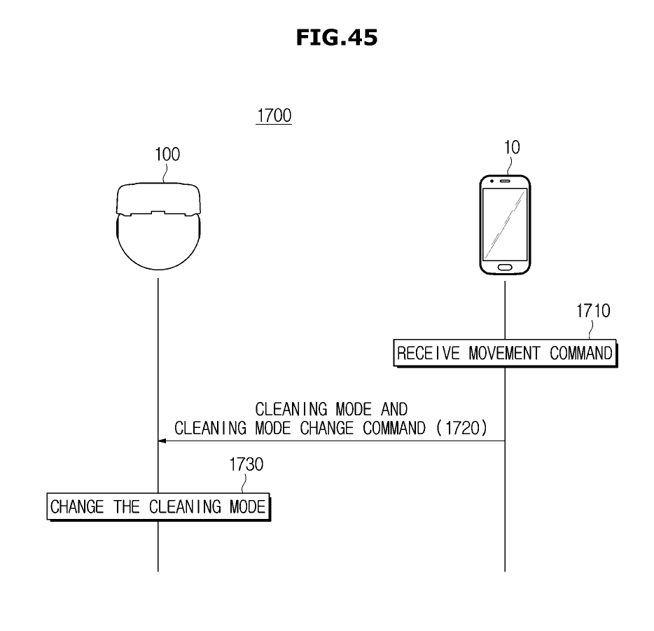

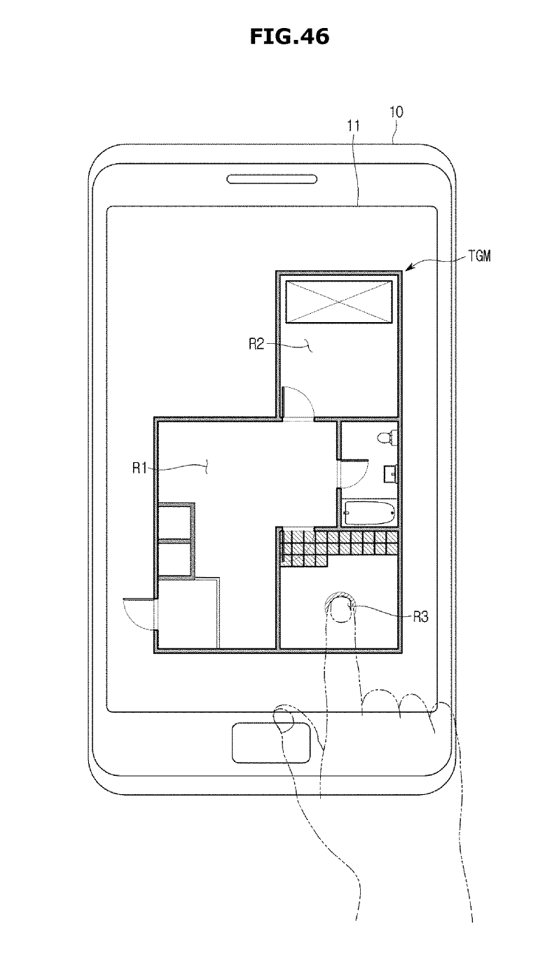

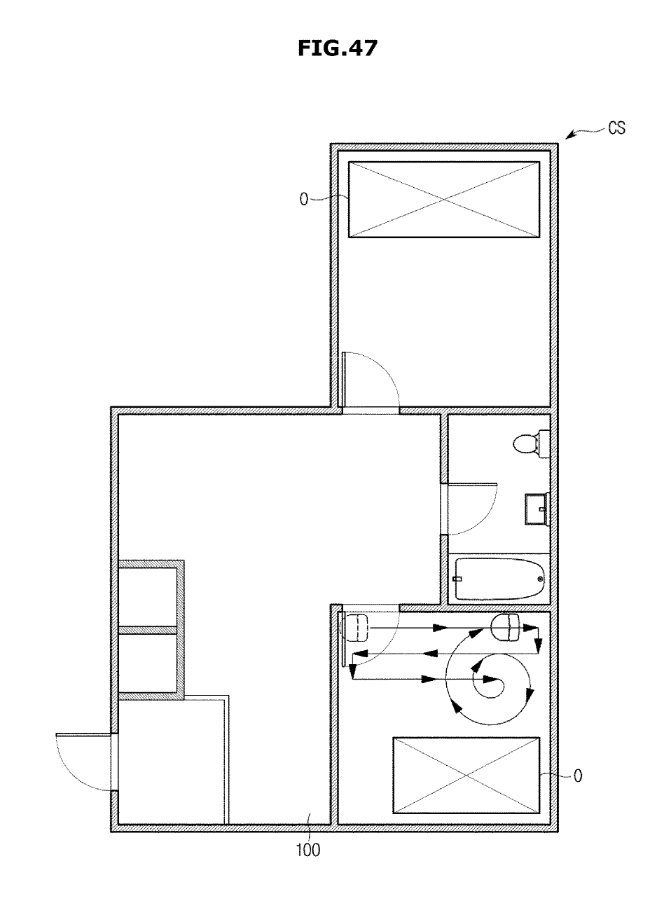

FIG. 45 illustrates another example of interaction between the robot cleaner and the user equipment (UE) according to an embodiment of the present disclosure. FIGS. 46 and 47 illustrate examples of interaction between the robot cleaner and the user equipment (UE) according to the method of FIG. 45.

A method 1700 for allowing the robot cleaner 100 to interact with the user will hereinafter be described with reference to FIGS. 45 to 47.

The user equipment (UE) 10 may receive a cleaning mode change command from the user when displaying the cleaning progress state in operation 1710.

As described above, the user equipment (UE) 10 may display the cleaning progress state on the topological-grid map (TGM).

In this case, the user equipment (UE) 10 may command the robot cleaner 100 operated in the cleaning mode to change to another cleaning mode.

For example, as shown in FIG. 46, assuming that the robot cleaner 100 is cleaning the third cleaning region R3, the user may input an intensive cleaning command of the third cleaning region R3 to the robot cleaner 100 through the user equipment (UE) 10.

In more detail, the user may touch the third cleaning region R3 of the topological-grid map (TGM) displayed on the user equipment (UE) 10, and may input an intensive cleaning command of the third cleaning region R3 through the user equipment (UE) 10.

In addition, the user may verbally input an intensive cleaning command of the third cleaning region R3 to the robot cleaner 100.

The user may combine the name “kid's room” of the third cleaning region R3 with the intensive cleaning command “intensive cleaning”, such that the user may input a voice command “intensive cleaning of kid's room”. The user equipment (UE) 10 having received the voice command may process the received voice command, such that the user equipment (UE) 10 can recognize the intensive cleaning command of the third cleaning region.

Thereafter, the user equipment (UE) 10 may transmit a cleaning mode to be changed and a command for changing the cleaning mode to the robot cleaner 100 in operation 1620.

The robot cleaner 100 may receive the cleaning mode to be changed and the cleaning mode change command through the communicator 190.

The robot cleaner 100 having received the cleaning mode change command may change the cleaning mode to a user-designated cleaning mode in operation 1730.

In more detail, upon receiving the cleaning mode change command, the robot cleaner 100 may stop cleaning.

Thereafter, the robot cleaner 100 may change the cleaning mode to the user-designated cleaning mode, and may clean the cleaning region according to the changed cleaning mode.

For example, as shown in FIG. 47, the robot cleaner 100 may change the cleaning mode to the intensive cleaning mode, such that the robot cleaner 100 may clean the cleaning region according to the intensive cleaning mode.

As described above, the robot cleaner 100 having received the cleaning mode change command from the user may continuously perform cleaning after switching to the user-input cleaning mode.

In addition, the user may input the cleaning mode to each of the cleaning regions (R1, R2, R3).

For example, the user may input a first cleaning mode to the first cleaning region R1, may input a second cleaning mode to the second cleaning mode R2, and may input a third cleaning mode to the third cleaning mode R3.

The robot cleaner 100 may store the user-input cleaning mode for each of the cleaning regions (R1, R2, R3), and may perform cleaning in different cleaning modes according to the cleaning regions (R1, R2, R3).

For example, the robot cleaner 100 may enter the first cleaning mode to clean the first cleaning region R1, may enter the second cleaning mode to clean the second cleaning region R2, and may enter the third cleaning mode to clean the third cleaning region R3.

As is apparent from the above description, the robot cleaner and the method for controlling the same according to embodiments can include topological and grid maps stored before first traveling in a cleaning space.

The robot cleaner and the method for controlling the same according to embodiments can modify topological and grid maps stored before first traveling in a cleaning space according to a user input signal.

The robot cleaner and the method for controlling the same according to embodiments can modify topological and grid maps stored before first traveling in a cleaning space according to a traveling record.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A robot cleaner comprising:
a driver configured to move the robot cleaner;
a storage configured to store a topological map and a grid map, each generated based on a floor plan of a cleaning space; and
a controller configured to control the driver such that the robot cleaner travels in the cleaning space based on the topological map and the grid map stored in the storage,
wherein the topological map and the grid map are generated prior to initial traveling of the robot cleaner in the cleaning space.

2. The robot cleaner according to claim 1, wherein the topological map includes:
cleaning nodes indicating cleaning regions contained in the cleaning space, and
a connectivity relationship between the cleaning nodes.

3. The robot cleaner according to claim 2, wherein:
the cleaning nodes are each generated from at least one of letters, numbers, symbols, and images displayed on the floor plan.

4. The robot cleaner according to claim 3, wherein the connectivity relationship between the cleaning nodes is generated from a shortest path between at least one of letters, numbers, symbols, and images displayed on the floor plan.

5. The robot cleaner according to claim 1, wherein
the grid map is divided into a plurality of cleaning blocks, and
the cleaning blocks include position information of the cleaning blocks, respectively, and are grouped into at least one cleaning region.

6. The robot cleaner according to claim 5, wherein the grid map is generated from a traveling simulation of a three-dimensional (3D) spatial model of the floor plan.

7. The robot cleaner according to claim 6, wherein:
the grid map is generated based on a traveling record obtained while a 3D robot model of the robot cleaner travels in the 3D spatial model.

8. The robot cleaner according to claim 1, wherein the controller modifies the topological map or the grid map based on a user input.

9. The robot cleaner according to claim 1, further comprising:
an obstacle detector configured to detect an obstacle located in the cleaning space,
wherein the controller determines a position of the main body in the topological map and the grid map based on an output signal of the obstacle detector.

10. The robot cleaner according to claim 1, wherein
the controller modifies the topological map and the grid map based on a traveling record obtained during traveling.

11. A method for controlling a robot cleaner, comprising:
prior to initial traveling of the robot cleaner in a cleaning space, storing a topological map and a grid map generated based on a floor plan of the cleaning space in a storage of the robot cleaner;
controlling the robot cleaner to travel in the cleaning space based on the topological map and the grid map stored in the storage; and
modifying the topological map and the grid map stored in the storage when the robot cleaner travels in the cleaning space.

12. The method according to claim 11, wherein the topological map includes:
cleaning nodes indicating respective cleaning regions contained in the cleaning space, and
a connectivity relationship between the cleaning nodes.

13. The method according to claim 12, wherein:
the at least one cleaning node is generated from at least one of letters, numbers, symbols, and images displayed on the floor plan.

14. The method according to claim 13, wherein the connectivity relationship between the cleaning nodes is generated from a shortest path between at least one of letters, numbers, symbols, and images displayed on the floor plan.

15. The method according to claim 11, wherein
the grid map is divided into a plurality of cleaning blocks, and
the cleaning blocks include position information of the cleaning blocks respectively, and are grouped into at least one cleaning region.

16. The method according to claim 15, wherein the grid map is generated from a traveling simulation of a three-dimensional (3D) spatial model of the floor plan.

17. The method according to claim 16, wherein:
the grid map is generated based on a traveling record obtained while a 3D robot model of the robot cleaner travels in the 3D spatial model.

18. The method according to claim 11, wherein the controlling the robot cleaner to travel in the cleaning space includes:
determining the position of the robot cleaner in the topological map and the grid map stored in the storage; and
generating a traveling path on the basis of the topological map and the grid map stored in the storage.

19. The method according to claim 18, wherein the modifying the topological map and the grid map when the robot cleaner travels in the cleaning space includes:
detecting a position of an obstacle located in the cleaning space;
detecting a movement of the robot cleaner; and
modifying the topological map and the grid map stored in the storage based on the detected position of the obstacle and the detected movement of the robot cleaner.

20. The method according to claim 11, further comprising:
modifying the topological map and the grid map according to a user input.
